(19) United States
(12) Patent Application Publication
(10) Pub. No.: US 2026/0253103 A1
(43) Pub. Date: Aug. 27, 2026

(54) Systems and Methods for Delivering Personalized, Context-Aware, and Multimodal Content in an AI-Generated Response

(71) Applicant: Bao Q. Tran, Saratoga, CA (US)

(72) Inventor: Bao Q. Tran, Saratoga, CA (US)

(21) Appl. No.: 19/064,476

(22) Filed: Feb. 26, 2025

(51) Int. Cl. G06Q 30/0242; G06F 16/3329; G06F 16/335; G06Q 20/38; G06Q 30/0273

(52) U.S. Cl. CPC G06Q 30/0246; G06F 16/33295; G06F 16/335; G06Q 20/382; G06Q 30/0275; G06Q 2220/00

(57) ABSTRACT

Systems and methods are disclosed for integrating targeted, personalized advertising within AI-generated responses. A user query is received and processed by a large language model to produce a response, which is then analyzed to identify suitable advertising opportunities. Based on real-time contextual analysis, user profile data, and past interactions, one or more hyperlinked or text-based content units are selected and embedded at optimal positions determined by the semantic structure of the response. The final integrated response is presented to the user, with interactions such as click-through rates and time spent tracked to inform continuous machine learning optimization of content selection, placement, and personalization. Additional embodiments include features like privacy controls, blockchain-secured content transactions, augmented reality presentations, federated learning for data privacy, and dynamic pricing or bidding systems, enabling the framework to adapt to various input types and cultural contexts.

### BACKGROUND OF THE INVENTION

In recent years, rapid advancements in digital technologies have transformed the landscape of content creation. The widespread adoption of artificial intelligence has enabled the generation of dynamic media content across various digital platforms, prompting new challenges and opportunities for effectively reaching target audiences. Simultaneously, advertisers face evolving consumer expectations for relevance and personalization in a cluttered digital environment, highlighting the need for approaches that can seamlessly integrate promotional content within contextually rich media. As digital ecosystems continue to expand, there is an increasing emphasis on developing methodologies that not only adapt to individual user preferences but also respond to the nuances of the surrounding digital content, thereby fostering more engaging and meaningful interactions between brands and consumers.

### SUMMARY OF THE INVENTION

A system and method are provided for generating personalized content that integrate with an AI interface. In one implementation, a large language model processes user queries while incorporating individual user profiles that include preferences, interaction histories, and context across multiple interactions to generate responses embedding hyperlinked content units based on identified opportunities; user engagement with the AI generated response is tracked and used to continuously optimize the content selection process. Additional embodiments include generating personalized video contents by converting user portrait images into dynamic talking avatars synchronized with generated or uploaded audio, as well as creating interactive voice-activated ads and embedding user-generated voice samples into audio content. Other features include modules for uploading images and animating them within content templates, combining user-provided images, voice samples, and text inputs for cohesive video ads, inserting dynamic voice-interactive ads into podcasts, capturing viewer images for near real-time content customization, developing augmented reality ads using facial recognition and AR filters, and generating personalized video game ads that integrate player avatar data and update based on user progress.

Advantages of one implementation may include one or more of the following:
Enhanced Personalization: By leveraging comprehensive user profiles that incorporate preferences, interaction histories, and contextual data from multiple interactions, one implementation enables the delivery of highly tailored contents. This personalization increases relevance for individual users, improving the overall engagement rate.
Adaptive Content Placement: The system's integration with a large language model allows for real-time processing of user queries. This capability supports the dynamic insertion of hyperlinked content units where contextually relevant, ensuring that ads are seamlessly embedded within surrounding media content.
Multi-Modal Content Generation: One implementation supports a diverse range of advertisement formats, including text, dynamic video (with personalized talking avatars), interactive voice-activated ads, augmented reality (AR) contents, and personalized video game ads. This flexibility facilitates effective communication across various digital platforms and consumer touchpoints.
Continuous Optimization Through Interaction Feedback: By tracking user engagement metrics—such as clicks, interaction duration, and conversion events—the system can continuously refine content selection and placement strategies. This feedback loop enhances the overall effectiveness of promotional content over time.
Real-Time Customization: Features like capturing viewer images for near real-time content customization and integrating facial recognition with AR filters enable contents to be rapidly adapted in response to current user context. This responsiveness can lead to more engaging and contextually appropriate advertising experiences.
Seamless Integration with Digital Ecosystems: The system's ability to incorporate user-provided content (e.g., images, voice samples, text inputs) into cohesive video, audio, and interactive ads promotes not only brand messaging but also user-generated content. This collaborative approach may enhance consumer engagement and brand loyalty.
Cross-Platform Scalability: By designing one implementation to operate across a range of digital environments—from social media platforms to podcasts and digital gaming contexts—the method addresses the growing need for advertisers to reach consumers in various online ecosystems reliably and effectively.

These advantages collectively support the overarching goal of fostering more engaging interactions between brands and consumers, ensuring that advertisers can meet evolving consumer expectations for relevance, personalization, and interactivity in increasingly complex digital environments.

In a further aspect, a method is provided for delivering targeted content in AI generated responses. In one aspect, the method includes receiving a user query through an AI interface. In one aspect, the method comprises processing the user query using a large language model (LLM) to generate a response. In one aspect, the method involves analyzing the generated response to identify relevant advertising opportunities. In one aspect, the method includes selecting one or more hyperlinked content units based on the identified opportunities. In one aspect, the method further involves embedding the selected hyperlinked content units within the generated response. In one aspect, the method includes presenting the response with the embedded hyperlinked content units to the user via the AI interface. In one aspect, the method further comprises tracking the user interaction with the embedded hyperlinked content units.

In a further aspect, a method is provided for delivering personalized, context-aware advertising content in AI-generated responses. In one aspect, a user profile database is established to store individual user preferences and interaction history. In one aspect, a user query is received through an AI interface, the user is identified, and their associated profile is retrieved from the database. In one aspect, the user query is processed using a large language model that incorporates the user's preferences and interaction history while maintaining context awareness across multiple interactions within a session. In one aspect, the generated response and the user profile are analyzed to identify relevant advertising opportunities. In one aspect, one or more text-based contents with associated hyperlinks are selected based on the identified advertising opportunities, the user's preferences and interaction history, and the current context of the interaction. In one aspect, the selected contents are seamlessly integrated into the generated response, appearing as natural, contextually relevant parts of the text while remaining distinguishable from the AI-generated content through cues. In one aspect, the response with embedded text-based contents and hyperlinks is presented to the user through the AI interface. In one aspect, user interactions with the embedded contents—such as click-through rates, time spent viewing or interacting with the advertising content, and related queries or actions—are tracked. In one aspect, the user's profile is updated based on their interactions with both the contents and the AI-generated response. In one aspect, machine learning algorithms are used to continuously optimize the content selection and integration process based on individual user interaction data, aggregated performance metrics across user segments, and evolving advertising content and formats.

Advantages of one implementation may include one or more of the following:
Enhanced Advertising Relevance: By leveraging a large language model's contextual and semantic analysis capabilities along with user-specific data, the system can identify and deliver contents that are more precisely aligned with the user's interests and current needs. This targeted delivery increases the likelihood of content engagement and conversion.
Improved User Engagement and Experience: Integrating hyperlinked content units naturally within AI-generated responses minimizes disruption to the user experience. The seamless presentation of contextually relevant contents can lead to higher user satisfaction and engagement, as it maintains the flow and natural tone of the interaction.
Real-Time Data Analytics and Optimization: The method's capability to continuously track user interactions—such as click-through behavior and time spent engaging with the ads—enables real-time performance analytics. This data can be used to fine-tune the content selection and placement algorithms, optimizing advertising effectiveness on an ongoing basis.
Personalization and Context Awareness: The use of a user profile database containing individual user preferences and interaction history allows the system to deliver highly personalized content. Machine learning algorithms analyze both the context of the user query and the historical data to adapt the advertising content, ensuring that the ads remain relevant to the user even as their interests evolve.
Privacy-Enhanced Targeting: By incorporating privacy considerations into the user identification and profile management processes, one implementation can deliver targeted contents while adhering to applicable privacy regulations. The focus on individualized profiles means that only non-sensitive, consented data is used for content personalization.
Scalability and Flexibility: The integration of advanced AI with dynamic content selection and embedding techniques supports scalability. One implementation can be adapted for various platforms and formats, including multiple types of content units, without compromising the integrity of the AI-generated response.
Continual Learning and Improvement: Machine learning capabilities allow the system to continuously update and refine content selection strategies based on both individual user feedback and aggregated performance metrics. This iterative improvement process can lead to higher overall system efficiency and advertising ROI over time.

In another aspect, a method is provided for generating personalized video advertisements by uploading a user's portrait image, converting the static image into a dynamic talking avatar using artificial intelligence, synchronizing the avatar's lip movements with a generated or uploaded audio script, and embedding the talking avatar into a video advertisement template. In related embodiments, systems are disclosed for creating interactive voice-activated advertisements that include a natural language processing module for interpreting voice commands, a response generation module to produce contextual advertisement content, and an audio output module for delivering personalized audio ads. Other embodiments include methods for capturing a user's voice sample, cloning the voice using artificial intelligence, and integrating the cloned voice into audio advertisements. Additional systems are described for creating dynamic image-based advertisements that feature an image upload module to receive user photos, an AI-powered image animation module to add motion to static images, and an ad template library to integrate the animated images into pre-designed layouts. Further methods integrate user-provided images, voice samples, and text inputs to generate multi-modal personalized advertisements, including cohesive video advertisements featuring the user's likeness and voice. Other disclosed systems provide for creating voice-interactive podcast advertisements with a content analysis module to identify optimal ad insertion moments, a dynamic ad insertion module to place interactive ads during the podcast, and a user response tracking module to measure engagement. One embodiment of a method for personalizing digital out-of-home advertisements involves capturing images of viewers near the display, rapidly generating custom ad content featuring their likenesses, and displaying these personalized ads in near real-time. An augmented reality advertisement system is also disclosed that includes a user facial recognition module, an AR filter generation module to produce customized filters incorporating user features, and an ad placement module for seamlessly integrating personalized AR ads into various platforms. Lastly, a method for generating personalized video game advertisements is provided that involves capturing player avatar data from a game, integrating the player's avatar into in-game advertising content, and dynamically updating the ads based on player progress and preferences.

Advantages of one implementation may include one or more of the following:
Enhanced Personalization: One implementation enables the creation of highly personalized advertisements by incorporating user-generated images, voice samples, and other inputs. This level of customization can improve ad relevance and increase user engagement.
Increased Engagement and Conversion: By dynamically tailoring advertising content to reflect a user's likeness, voice, or preferences, the method can capture attention more effectively. This targeted approach may lead to higher click-through rates and conversion metrics compared to traditional, non-personalized ads.
Real-Time Adaptability: Systems that rapidly process and integrate live data—such as images captured near digital displays or avatars generated on the fly—allow for dynamic ad insertion that adapts in near real time to the current context or viewer behavior.
Efficient Content Creation: The use of artificial intelligence to automate tasks such as image animation, voice cloning, and lip syncing minimizes the need for extensive manual intervention. This can reduce production costs and accelerate the advertisement creation process.
Multi-Modal Integration: One implementation supports the seamless merging of diverse data streams (e.g., images, voice, text) into cohesive advertisement content. This multi-modal approach allows advertisers to deliver a richer, more immersive viewer experience across digital, video game, and augmented reality platforms.
Improved User Experience: By providing advertisements that recognize and respond to individual user characteristics and preferences, one implementation may enhance the perceived value of the advertising experience, fostering a stronger connection between the consumer and the brand.
Enhanced Interaction and Responsiveness: The inclusion of interactive features such as voice-activated controls and natural language processing enables two-way communication. Users can engage with ads more directly, leading to improved feedback loops and more tailored content delivery.
Scalability Across Platforms: The framework is adaptable to various advertising mediums-ranging from digital out-of-home displays and online video to podcasts and augmented reality-making it versatile and applicable to a wide range of marketing strategies.
Data-Driven Optimization: The continuous collection and analysis of user interactions allow for real-time adjustments to ad content. This iterative optimization can lead to more effective campaigns and a better return on investment by leveraging consumer behavior data.

Each of these advantages supports the overall objective of transforming how advertising content is created, delivered, and engaged with, making the methods and systems disclosed herein particularly valuable in the modern, data-rich advertising environment.

These advantages collectively position one implementation as a significant advancement in delivering personalized, context-aware advertising integrated seamlessly within AI-generated responses, ultimately enhancing both user experience and advertising efficacy.

### BRIEF DESCRIPTION OF DRAWINGS

FIG. 1 shows an exemplary flowchart showing a process for integrating hyperlinked content units into AI-generated responses based on user queries.

FIG. 2 shows an exemplary flowchart diagram with steps for analyzing semantic structure for content placement and providing content disclosure.

FIG. 3 shows an exemplary flowchart depicting a process for personalized advertising integration in AI-generated content.

FIG. 4 shows an exemplary flowchart showing the process of creating a talking avatar from a user's portrait image, synchronizing lip movements with audio, and embedding it into a video content.

FIG. 5 shows an exemplary flowchart with modules for natural language processing, response generation, and audio output.

FIG. 6 shows an exemplary flowchart diagram outlining steps for capturing and using a cloned voice for personalized audio contents.

FIG. 7 shows an exemplary flowchart with steps for uploading, animating, and integrating user images into content templates

FIG. 8 shows an exemplary flowchart showing steps to create video ads using user-provided content and AI.

FIG. 9 shows an exemplary flowchart showing modules for podcast content analysis, dynamic content insertion, and user response tracking.

FIG. 10 shows an exemplary flowchart illustrating a process for personalized advertising using viewer images, custom content generation, and near real-time display.

FIG. 11 shows an exemplary flowchart with modules for facial recognition, AR filter generation, and content placement.

FIG. 12 shows an exemplary flowchart showing a process from capturing player avatar data to dynamically updating ads based on player progress.

FIG. 13 shows an exemplary flowchart illustrating a process of analyzing user content, generating dynamic ads, and optimizing through feedback loops

FIGS. 14-15 show an exemplary multimodal contents embedded in LLM chats or responses.

FIG. 16 shows an exemplary flowchart depicting a process for creating a talking avatar from a user's portrait for video advertisements using AI technology.

FIG. 17 shows an exemplary flowchart illustrating a process involving podcast content analysis, dynamic ad insertion, and user response tracking.

FIG. 18-19 show illustrations of exemplary processes for AR ad creation.

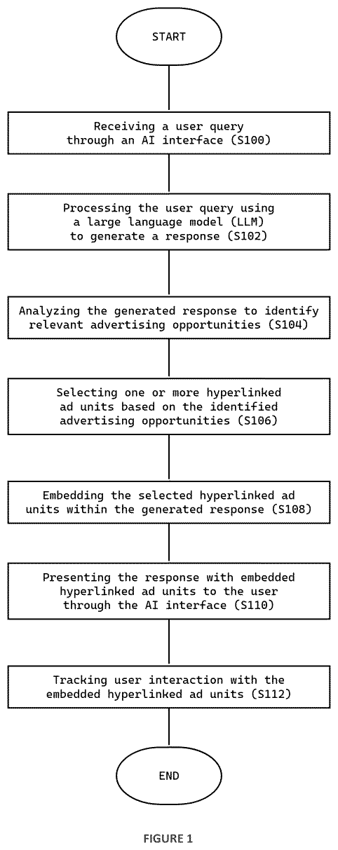

### DETAILED DESCRIPTION OF THE INVENTION

The present disclosure describes methods and systems for delivering targeted, personalized advertising content within responses generated by an artificial intelligence (AI) interface. In one embodiment, a user query is received through the AI interface and processed by a large language model to generate a response. The generated response is then examined for relevant advertising opportunities, after which one or more hyperlinked content units are selected and seamlessly embedded within the response. The final content such as a video, responsive text or ad is delivered to the user, ensuring that the contents remain contextually relevant while being easily distinguishable from the primary AI-generated text. The system also tracks user interactions with these embedded contents and uses the collected data to continuously optimize content selection and integration. In certain embodiments, a user profile database stores individual preferences and interaction history. By incorporating this user-specific data along with the contextual cues captured during each session, the AI system generates responses and integrates contents that align more precisely with the user's current interests and needs. Machine learning techniques are utilized to refine the process over time, ensuring enhanced relevance and improved engagement with the advertising content.

One implementation provides a system and method for generating personalized contents that integrate seamlessly with an AI interface. In an embodiment, the system begins by receiving a user query through an AI interface (S100). The received query is then processed by a large language model (S102) which generates a response that is subsequently analyzed to identify advertising opportunities (S104). Based on these identified opportunities, the system selects one or more hyperlinked content units (S106) and embeds them within the generated response (S108), ensuring that the final output is presented to the user via the AI interface (S110). User interactions with the embedded contents, including click-through actions and engagement durations, are tracked (S112) to facilitate continuous optimization of the content selection and integration process.

Additional embodiments of one implementation extend these capabilities by incorporating user profile data stored within a dedicated database, which includes individual preferences and historical interaction information. By leveraging this data, the system adapts the response generation process to include user-specific content placements that align with their interests. In further embodiments, one implementation supports the generation of personalized video contents by uploading a user's portrait image and converting it into a dynamic talking avatar (S400, S402), with synchronized audio (S404) that is embedded into a video content template (S406). Moreover, interactive and voice-activated contents are produced through modules that understand natural language voice commands (S500) and generate personalized contextual content (S502, S504).

Large Language Models (LLMs) like Llama and GPT, when customized for ad generation, leverage their sophisticated architecture to create compelling, context-aware advertising content that can revolutionize the digital marketing landscape. These models, built on the foundation of the transformer architecture, utilize a decoder-only structure for autoregressive text generation, which is particularly well-suited for crafting persuasive and engaging ad copy. The core components of these LLMs can be fine-tuned and optimized specifically for the nuanced task of ad creation, enabling the generation of highly personalized, contextually relevant, and effective advertising content.

At the heart of these models is the embedding layer, which takes on critical importance in the context of ad generation. This layer converts input tokens—which in the case of advertising might include product features, brand voice characteristics, target audience demographics, and marketing campaign objectives—into high-dimensional vector representations. These embeddings capture the semantic relationships between different aspects of the advertising brief, allowing the model to understand the subtle interplay between product attributes, brand identity, and consumer preferences. By training these embeddings on vast corpora of successful advertising copy, marketing case studies, and consumer behavior data, the model can develop a nuanced understanding of what makes an advertisement effective for different audience segments.

The attention mechanism, a cornerstone of LLMs, becomes a powerful tool for crafting persuasive ad copy when adapted for advertising purposes. This component allows the model to focus on relevant aspects of the input, such as key selling points, emotional triggers, or unique value propositions, regardless of their position in the sequence. In the context of ad generation, this translates to the ability to weave together compelling narratives that highlight the most salient features of a product or service, while maintaining a coherent and engaging story throughout the advertisement. The multi-head attention used in these models can be fine-tuned to simultaneously consider multiple aspects of the advertising brief, such as brand guidelines, target audience preferences, and current market trends, ensuring that the generated ad copy is not only persuasive but also aligned with the broader marketing strategy.

The feedforward layers in LLMs, when customized for ad generation, can be optimized to process marketing-specific patterns and relationships. These layers can be trained on vast datasets of successful advertising campaigns, consumer response data, and market research findings. This allows the model to learn complex patterns in consumer behavior, market trends, and effective advertising techniques. For instance, the model could learn to generate compelling calls-to-action that are statistically more likely to drive conversions for specific product categories or audience segments. It could also learn to craft emotional appeals that resonate with different demographic groups, or to generate product descriptions that highlight features in a way that aligns with current consumer preferences and pain points.

Normalization techniques, such as the pre-normalization used in Llama, play a crucial role in ensuring training stability when adapting these models to the nuanced language of advertising. This is particularly important given the often subjective and creative nature of advertising copy. By maintaining stable gradients during training, these normalization techniques allow the model to learn the subtle distinctions between effective and ineffective ad copy, even when dealing with highly varied and creative input data. This stability is essential for producing consistent, high-quality ad content across different campaigns and product categories.

Architectural features like Rotary Positional Embeddings (RoPE) can be leveraged to maintain coherence in longer-form ad content, such as storytelling advertisements or detailed product descriptions. RoPE encodes the relative positions of tokens mathematically, which is particularly useful in advertising contexts where the order and flow of information can significantly impact the ad's effectiveness. This feature ensures that the beginning and end of an advertisement are contextually aligned, maintaining a coherent narrative or argument throughout the piece. For example, in a long-form video ad script, RoPE can help ensure that the opening hook, product features, and call-to-action are presented in a logical and compelling sequence.

The choice of activation functions, such as the SwiGLU used in Llama, can be optimized for generating creative and engaging ad copy. These activation functions introduce non-linearity into the model, allowing it to learn complex patterns in language usage that are particularly relevant to advertising. For instance, SwiGLU might be particularly effective at capturing the nuanced language patterns that make ad copy persuasive, such as the use of emotional triggers, rhetorical devices, or brand-specific tones of voice. By fine-tuning these activation functions on advertising-specific datasets, the model can become more adept at generating copy that not only conveys information but also evokes the desired emotional response in the target audience.

When it comes to model parameters, LLMs used for ad generation can be optimized for different scales of advertising needs. Smaller models with fewer parameters might be suitable for generating short-form ad copy like social media posts or banner ad text, where quick generation and deployment are key. Larger models with more layers, attention heads, and higher model dimensions could be employed for more complex advertising tasks, such as generating entire marketing campaigns, crafting long-form video scripts, or developing multi-channel advertising strategies. The scalability of these models allows for flexibility in deployment, catering to the diverse needs of different businesses and marketing objectives.

The training process for ad-generation LLMs involves exposure to massive amounts of text data, but with a specific focus on advertising and marketing content. This might include successful ad copies from various industries, consumer reviews and feedback, marketing strategy documents, and even competitor analyses. By training on this specialized dataset, the model learns not just language patterns, but also effective marketing strategies, consumer psychology, and industry-specific terminologies. This specialized training allows the model to generate ad content that is not only linguistically correct but also strategically sound and aligned with marketing best practices.

During inference, these ad-generation LLMs process input in two phases: the prefill phase and the decode phase. In the advertising context, the prefill phase might involve processing the initial advertising brief, which could include details about the product, target audience, campaign objectives, and brand guidelines. The decode phase then generates the actual ad copy, taking into account all the processed information from the prefill phase. This two-phase approach allows for the generation of highly tailored ad content that takes into account all relevant factors specified in the brief.

One of the key advantages of using LLMs for ad generation is their ability to create personalized content at scale. By incorporating user data, interaction history, and real-time context into the generation process, these models can produce ads that are tailored to individual users or specific audience segments. For instance, the model could generate different versions of an ad for different demographic groups, or even personalize ad copy in real-time based on a user's browsing history or current context. This level of personalization can significantly increase the relevance and effectiveness of advertising campaigns.

Moreover, these models can be designed to adapt and learn from user interactions and campaign performance data. By implementing feedback loops that incorporate metrics such as click-through rates, conversion rates, and engagement levels, the ad-generation LLM can continuously refine its outputs to improve performance over time. This creates a dynamic system where the model not only generates ads but also learns from their real-world performance to generate increasingly effective content.

Another important aspect of customizing LLMs for ad generation is ensuring compliance with advertising standards and regulations. The models can be trained on datasets that include regulatory guidelines and ethical advertising practices, ensuring that generated content adheres to legal and ethical standards. This could include avoiding false claims, maintaining appropriate disclosures, and respecting privacy regulations. The attention mechanisms in these models can be fine-tuned to pay special attention to these compliance factors, acting as a built-in compliance check during the ad generation process.

Furthermore, LLMs customized for ad generation can be integrated with other AI systems to create more comprehensive marketing solutions. For example, they could be combined with image generation AI to create multi-modal advertisements, or with predictive analytics models to forecast the performance of generated ad copy. This integration can create powerful tools that not only generate ad content but also provide insights into its potential effectiveness and suggest optimizations.

In conclusion, customizing LLMs like Llama and GPT for ad generation involves adapting their core components—from embedding layers and attention mechanisms to feedforward networks and activation functions—to the specific needs and nuances of advertising. By training these models on specialized datasets, optimizing their architecture for creative and persuasive language generation, and integrating them with broader marketing systems, we can create powerful tools that revolutionize the way advertising content is created and deployed. These customized LLMs have the potential to generate highly personalized, contextually relevant, and effective advertising content that adapts to individual user preferences, interaction history, and the current context of queries and responses. As these models continue to evolve and improve, they promise to bring unprecedented levels of efficiency, creativity, and effectiveness to the field of digital advertising.

Answer from Perplexity: pplx.ai/share

Through the use of machine learning algorithms, the system continuously optimizes the placement and content of the contents, ensuring that the contextual integration and presentation remain highly relevant and user-friendly. Each feature of one implementation works in concert to provide a robust and adaptive content generation system that enhances user engagement and maximizes the tailored delivery of advertising content.

In certain implementations, a user profile database is established for storing individual user preferences and interaction history, enabling the system to maintain contextual awareness across multiple interactions within a session. The large language model processes each new user query by integrating current input with stored user data, thereby generating responses that are personalized and contextually enriched. The system identifies advertising opportunities based on semantic analysis of both the generated response and the user profile. Based on these analyses, relevant text-based contents with associated hyperlinks are selected and inserted into the response. The response with the integrated contents is then delivered to the user through the AI interface, and subsequent interactions with the contents are tracked to further refine future advertising content and improve contextual relevance.

In another illustrative aspect of one implementation, the system automatically adjusts store inventory levels and triggers restock alerts based on completed orders and predicted demand. The functional element designated as S114 is configured to monitor order fulfillment and update inventory data in real time. In response to both completed orders and demand forecasts generated through predictive analytics, S114 initiates restock alerts when inventory levels fall below predetermined thresholds, thereby facilitating efficient inventory management and timely replenishment.

The system leverages an LLM to generate responses and integrate targeted advertising, which differs significantly from how a human would perform these tasks. LLMs can process user queries and generate responses at a scale and speed far beyond human capabilities. While a human could manually craft responses to individual queries, an LLM can handle thousands of queries simultaneously, generating coherent and contextually relevant responses in milliseconds. The analysis of generated responses to identify advertising opportunities is performed automatically by the system. A human would need to manually read and interpret each response, then brainstorm potential content opportunities-a time-consuming process that would be impractical at scale. The system can programmatically select and embed hyperlinked content units within the generated text. This level of seamless integration would be extremely difficult for a human to replicate manually, especially at high volumes and speeds. The ability to track user interactions with embedded content units in real-time across numerous responses is beyond human capacity. This automated tracking enables immediate data collection and analysis that would be impossible for a human to perform manually. LLMs can leverage vast amounts of data to personalize responses and content selections for individual users. A human would struggle to maintain consistent personalization across a large user base while also managing all other aspects of response generation and content integration. Thus, while a human could theoretically perform some aspects of this process for a limited number of interactions, the scale, speed, consistency, and integration capabilities described in the system are only achievable using an LLM and associated automated systems.

To optimize the LLM for the content placement in an AI response to a query, several modifications can be implemented. Precision reduction techniques can be applied to lower numerical precision from 32-bit to 8-bit or 4-bit, significantly enhancing computational efficiency without substantial performance loss. This optimization would allow for faster processing of user queries and generation of responses. Advanced attention mechanisms such as Flash Attention, Multi-Query Attention (MQA), and Grouped-Query-Attention (GQA) can be incorporated to improve memory utilization and reduce computational requirements, enabling more efficient analysis of generated responses for advertising opportunities. Architectural innovations like Alibi and Rotary Embeddings can be employed to handle long input sequences more efficiently, which is particularly useful when embedding hyperlinked content units within the generated response. Inference optimizations, including continuous batching and quantization, can be implemented to increase throughput and decrease latency, allowing for faster presentation of responses with embedded content units to users. Additionally, model merging techniques can be used to combine weights of existing pretrained models, potentially improving the LLM's ability to identify relevant advertising opportunities and select appropriate hyperlinked content units. These optimizations collectively enhance the LLM's performance in processing queries, generating responses, analyzing content for content placement, and tracking user interactions with embedded ads, making the entire process more computationally efficient and scalable.

To improve the computational performance of the described LLM-based advertising system, several specialized techniques can be employed. Precision reduction and quantization, such as lowering numerical precision from 32-bit to 8-bit or 4-bit, can significantly enhance efficiency by reducing memory requirements and speeding up calculations. Advanced attention mechanisms, including Flash Attention, Multi-Query Attention (MQA), and Grouped-Query-Attention (GQA), can optimize memory utilization and reduce computational demands, enabling more efficient analysis of generated responses and user profiles to identify advertising opportunities. Incorporating user embeddings during fine-tuning or inference allows the LLM to better understand users' preferences, historical patterns, and latent intent, enhancing its ability to generate personalized responses and select targeted ads. Retrieval-Augmented Generation (RAG) can dynamically retrieve and integrate relevant external information, such as user interaction history, to improve response accuracy and relevance. Continuous batching enables parallel processing of multiple requests, increasing throughput, while quantization tools like NVIDIA Triton server or DeepSpeed can further reduce latency. Dynamic content optimization (DCO) allows the LLM to generate content tailored to specific user personas, improving the relevance and effectiveness of selected contents. Additionally, real-time bid prediction using context vectors derived from user data enables informed content selection based on the current query context. Finally, adaptive response generation techniques allow the LLM to continuously learn from user feedback, refining its ability to align with individual preferences over time. Together, these optimizations enhance the system's computational efficiency while maintaining high-quality interactions and personalized content placements.

In one implementation, several specialized techniques are employed to improve the computational performance of the described LLM-based advertising system:
Lowering numerical precision from 32-bit to 8-bit or 4-bit can significantly enhance computational efficiency without substantial performance loss[1]. This technique reduces memory requirements and speeds up calculations, allowing for faster processing of user queries and generation of responses.
Implementing advanced attention mechanisms such as Flash Attention, Multi-Query Attention (MQA), or Grouped-Query-Attention (GQA) can improve memory utilization and reduce computational requirements[1]. These optimizations enable more efficient analysis of generated responses and user profiles for identifying advertising opportunities.
Employing user embeddings to contextualize the LLM during fine-tuning or inference can enhance its ability to identify relevant patterns and facilitate understanding of users' latent intent and temporal evolution[1]. This approach empowers LLMs with a deeper understanding of users' historical patterns, enabling more personalized responses and targeted content selection.
Implementing RAG can significantly improve the LLM's ability to incorporate relevant external information, such as user preferences and interaction history. By retrieving and composing context dynamically, RAG becomes a flexible optimization mechanism for constructing prompts that maximize response accuracy and relevance.
Employing continuous batching allows for parallel processing of multiple requests, significantly improving throughput. For example, use of NVIDIA Triton server and DeepSpeed for quantization can decrease latency and increase throughput, enabling faster analysis of generated responses and selection of contents.
Leveraging LLMs for dynamic content optimization (DCO) can enhance content customization and personalization[8]. By generating content tailored to specific user personas, DCO can improve the relevance and effectiveness of selected contents.
Utilizing the context vectors generated from user data, LLMs can assist in predicting the potential success of different ads[8]. This approach enables more informed content selection decisions based on the current context of the user's query and the AI's response.
Implementing techniques for adaptive response generation allows the LLM to continuously learn from user feedback and adapt to better align with individual preferences. This ongoing optimization process can improve the relevance of both generated responses and selected contents over time.

By implementing these specialized techniques, the LLM-based advertising system can achieve substantial improvements in speed, memory usage, and overall computational efficiency, while maintaining high-quality, personalized interactions and targeted content placements:

```
# Precision Reduction and Quantization
def reduce_precision(model):
  model.convert_to_int8( ) # Convert 32-bit floats to 8-bit integers
  return model
# Advanced Attention Mechanisms
def implement_flash_attention(model):
  model.attention = FlashAttention( ) # Replace standard attention with Flash Attention
  return model
# User Embeddings
def create_user_embedding(user_data):
  embedding = encode_user_preferences(user_data)
  return embedding
# Retrieval Augmented Generation
def rag_enhanced_generation(query, user_history):
  relevant_info = retrieve_relevant_info(query, user_history)
  enhanced_query = augment_query_with_info(query, relevant_info)
  response = generate_response(enhanced_query)
  return response
# Continuous Batching
def process_queries_in_batches(queries):
  batches = create_batches(queries)
  for batch in batches:
    process_batch_in_parallel(batch)
# Dynamic Content Optimization
def optimize_ad_content(ad, user_persona):
  optimized_ad = generate_tailored_content(ad, user_persona)
  return optimized_ad
# Real-Time Bid Prediction
def predict_ad_success(ad, user_context):
  success_probability = calculate_success_probability(ad, user_context)
  return success_probability
# Adaptive Response Generation
def adapt_model(model, user_feedback):
  updated_model = fine_tune_model(model, user_feedback)
  return updated_model
# Main process
def optimized_ad_placement_process(user_query, user_profile):
  model = reduce_precision(load_model( ))
  model = implement_flash_attention(model)
  user_embedding = create_user_embedding(user_profile)
  response = rag_enhanced_generation(user_query, user_profile[‘history’])
  ad_opportunities = analyze_for_ad_opportunities(response, user_embedding)
  optimized_ads = [optimize_ad_content(ad, user_profile) for content in ad_opportunities]
  ad_success_probabilities = [predict_ad_success(ad, user_embedding) for content in
optimized_ads]
  selected_ad = select_best_ad(optimized_ads, ad_success_probabilities)
  final_response = embed_ad_in_response(response, selected_ad)
  return final_response
# Continuous adaptation
def continuous_improvement(model, user_feedback):
  return adapt_model(model, user_feedback)
```

The above pseudocode outlines the key performance enhancements discussed earlier, focusing on improving computational efficiency in line with Alice guidelines. The code demonstrates how precision reduction, advanced attention mechanisms, user embeddings, retrieval augmented generation, continuous batching, dynamic content optimization, real-time bid prediction, and adaptive response generation can be implemented to optimize the LLM-based advertising system's performance.

In embodiments utilizing the system, after a query is received, the query is forwarded to a large language model that interprets natural language input. In the step indicated by reference label S102, the model processes the user query to generate a coherent and contextually relevant response. The large language model analyzes the query's syntax and semantic content, which enables it not only to formulate an appropriate reply but also to set the stage for the subsequent integration of advertising content. This processing ensures that the generated response reflects a deep understanding of the user input, thereby supporting further dynamic content placement and personalization in later stages.

The process of selecting one or more hyperlinked content units based on the identified advertising opportunities (S106) involves a systematic analysis of the content generated by the large language model to determine appropriate points for content insertion. The method integrates evaluation criteria derived from user profiles, contextual cues from the query, and real-time interaction data, which collectively inform the decision-making algorithms in identifying content units that are most relevant to the user's current interests. Based on the assessment, hyperlinked content units that meet predetermined standards and engagement potential are retrieved from an available content repository. This selection process ensures that the embedded content units not only complement the natural flow of the generated response but also maintain clear differentiation as sponsored content, thus optimizing user experience while supporting advertising objectives.

The system integrates the selected hyperlinked content units into the generated response by combining the sponsored content with the AI-produced output at carefully determined points. In this embodiment, after the content opportunities are identified and one or more hyperlinked content units are chosen, the process embeds these content units within the AI-generated response in a manner that preserves the overall coherence and readability of the response. The embedding process, represented by reference label S108, ensures that the inserted content appears as an integral part of the response while being easily distinguishable from the non-sponsored content. The positioning of the content units is optimized according to the semantic structure of the response to ensure that their inclusion minimally disrupts the natural flow of information and provides users with a seamless, yet explicitly declared, advertising experience.

The system includes a mechanism to track user interactions with the embedded hyperlinked content units designated by reference label S112. This mechanism records various engagement parameters, such as the frequency and duration of clicks on the hyperlinked elements, along with additional behavioral metrics that indicate how users interact with the advertising content. The data collected via S112 is essential in providing feedback on the effectiveness of content placements and is used to continuously refine the selection and integration process. Specifically, the recorded user interactions inform subsequent adjustments in content deployment, ensuring that future ads are both contextually relevant and aligned with individual user preferences.

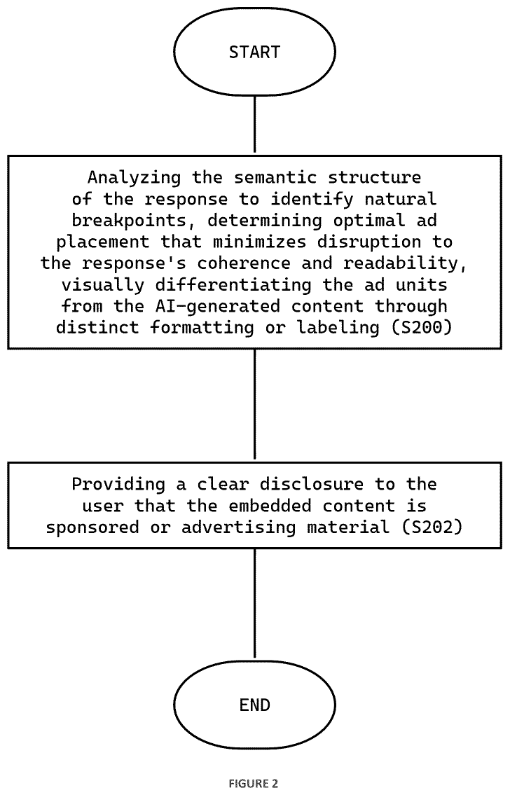

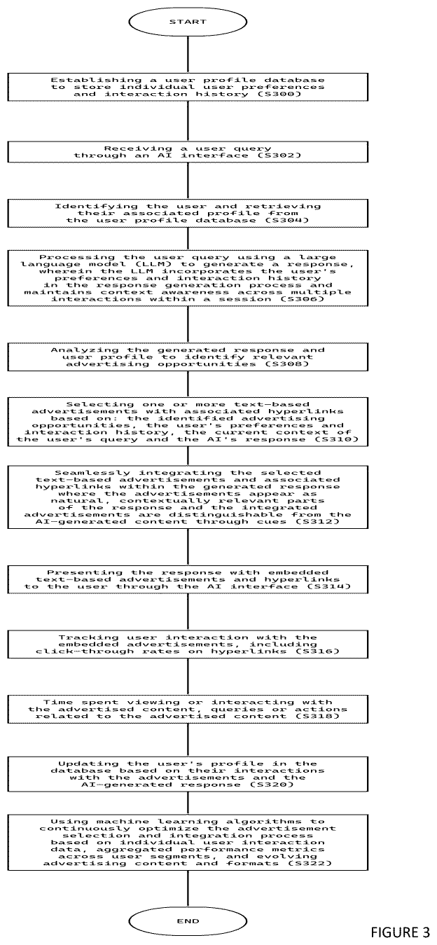

FIG. 2 illustrates a process for analyzing the semantic structure for content placement and providing content disclosure. The process begins with identifying natural breakpoints for optimal content placement to minimize disruptions in coherence and readability. Next, it visually differentiates ads from AI-generated content. Finally, it ensures that users receive clear disclosure concerning sponsored or advertising material.

In the system, a mechanism is implemented to ensure that users are informed when content embedded within an AI-generated response is sponsored or represents advertising material. This process (S202) employs distinct formatting or labeling that differentiates contents from non-commercial portions of the response. Such transparency is essential for maintaining user trust and ensuring compliance with advertising standards.

The process begins with establishing a user profile database (S300). This database is designed to store individual user preferences and interaction history. By maintaining detailed user profiles, the system can tailor contents more effectively to each user's unique interests and past interactions. This customization improves the relevance and engagement of the contents presented to users.

In the described process, “receiving a user query through an AI interface” (S302) refers to the initial step where the system acquires input from a user via an interactive artificial intelligence platform. This interface acts as the point of engagement, capturing the user's request or inquiry, and setting the stage for subsequent analysis and response generation within the personalized content system.

In the process of personalized advertising integration, one step involves identifying the user and retrieving their associated profile from a user profile database. This step is indispensable for tailoring AI-generated content to align with individual preferences and past interactions. By accessing stored user profiles, the system can incorporate personal data and interaction histories, thereby enhancing the relevance of contents presented within AI responses.

In the process of handling user queries, a large language model (LLM) is employed to generate responses. This LLM leverages the user's individual preferences and interaction history to tailor the response specifically to the user. Additionally, it maintains context awareness over multiple interactions within a single session, ensuring continuity and relevance in its outputs.

The reference label “S308” involves analyzing the response generated by a large language model in conjunction with the user's profile to pinpoint suitable advertising opportunities. This analysis leverages insights from the user's preferences and interaction history, ensuring that the identified contents align closely with the user's interests and the context of the interaction.

The process involves selecting text-based contents that are accompanied by hyperlinks. This selection is based on several factors: identifying relevant advertising opportunities, considering the user's preferences and interaction history, and analyzing the current context of the user's query and the AI's generated response. These steps ensure that the contents are contextually relevant and tailored to the user's profile, enhancing their engagement and interaction with the content presented.

The system presents the generated response, now embedded with selected text-based contents and hyperlinks, to the user via the AI interface. These contents are seamlessly integrated into the response, ensuring they appear as contextually relevant parts of the content while being visually distinguishable through specific cues. This presentation enhances user engagement by maintaining the coherence of the AI-generated content.

The reference labeled S316 pertains to the process of monitoring user interactions with the embedded contents. This process includes tracking how often users click on hyperlinks within the ads. The gathered data on user engagement helps evaluate the effectiveness of the contents in drawing user interest and interaction.

The method entails monitoring the period during which users interact with or view advertised content. This includes tracking the time users devote to the content, as well as recording any subsequent queries or actions. The collected information is vital for evaluating user engagement and refining content strategies.

The system updates the user's profile in the database by tracking the individual's interactions with both the contents and the AI-generated response. User engagement data, such as actions related to advertised content, is collected and analyzed. This information refines user profiles, enhancing future content personalization based on observed preferences and behavior patterns.

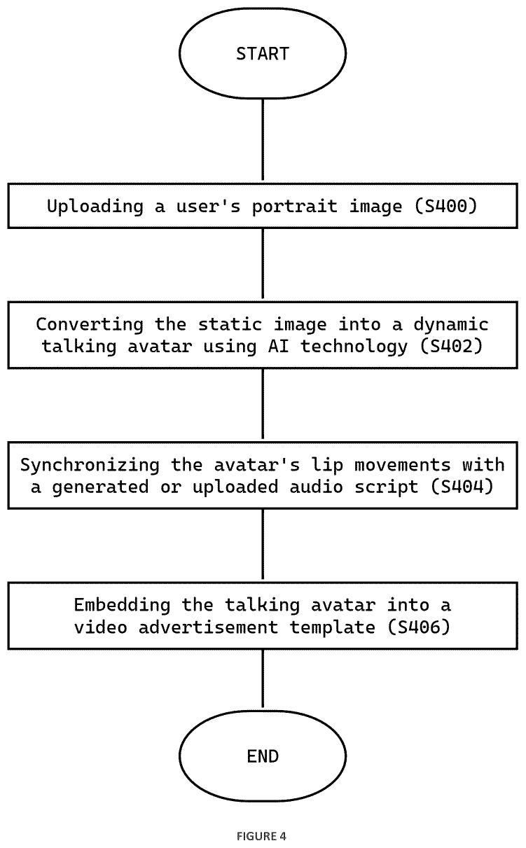

FIG. 4 illustrates the process of creating a talking avatar from a user's portrait image. This includes synchronizing the avatar's lip movements with audio and embedding it into a video content.

The process initiates with the action of receiving a user's portrait image, labeled as “S400”. This step marks the beginning of transforming a static photograph into a dynamic element within personalized video contents. Through this initial stage, the foundation is laid for subsequent conversion into an animated avatar.

The reference label refers to the process of making the talking avatar's lip movements match a generated or uploaded audio script. This is achieved using AI technology to ensure that the avatar appears to be speaking in sync with the provided audio, contributing to a seamless integration within video contents.

The reference label “S406” describes the step of embedding a talking avatar into a video content template. In this process, after converting a user's static portrait image into a dynamic talking avatar and synchronizing its lip movements with the provided audio script, the avatar is integrated into a pre-designed video content template. This ensures that the personalized avatar becomes part of the content, enhancing engagement by creating a tailored interactive experience for the viewer.

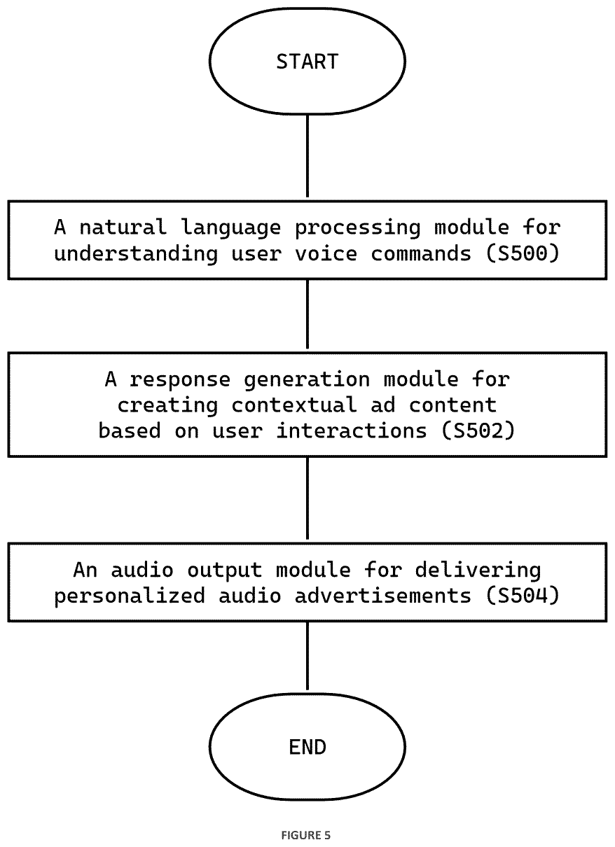

FIG. 5 illustrates a flowchart depicting modules for natural language processing, response generation, and audio output.

The system incorporates a natural language processing module designed to understand user voice commands. This module, identified by reference label S500, is responsible for interpreting the vocal inputs provided by users. It serves as a foundational component for processing spoken queries, ensuring that the subsequent steps in the content personalization process are based on accurately understood commands.

In FIG. 5, the reference label “a response generation module for creating contextual content based on user interactions (S502)” pertains to the component responsible for formulating advertising content tailored to user interactions. This module analyzes the user's queries and engagement, leveraging this data to generate contents that are contextually relevant. This approach ensures that the advertising material is seamlessly integrated into the user interaction flow, enhancing the likelihood of engagement by presenting contents as natural extensions of user interactions.

The audio output module, as depicted in step S504, is responsible for delivering personalized audio contents. This module functions by interfacing with user input and preference data to tailor audio content specifically for the individual listener. Through this personalization process, the module ensures that audio ads resonate more effectively with users, enhancing engagement and reinforcing the relevance of the content within the user's context.

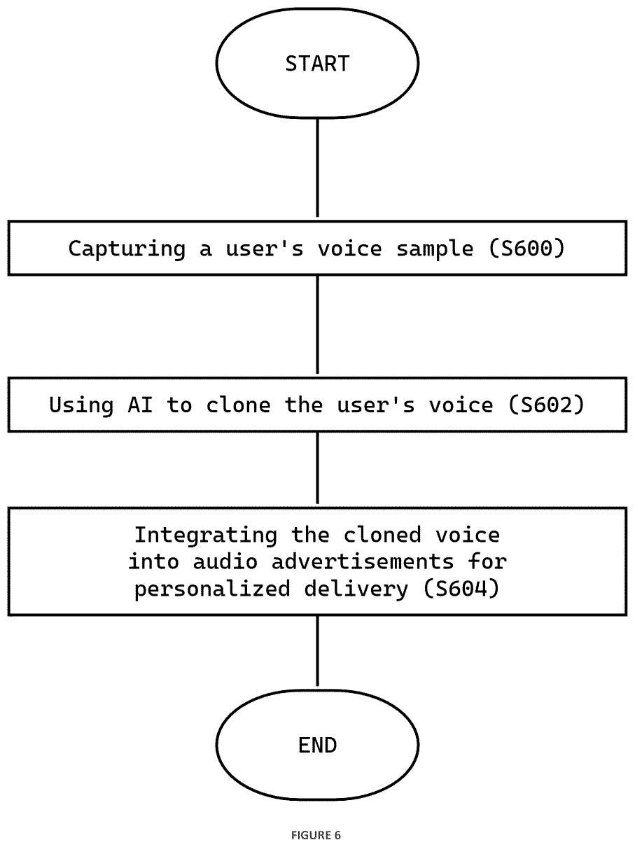

FIG. 6 illustrates the process of capturing and using a cloned voice for personalized audio contents. It involves capturing a user's voice sample, using AI to clone the user's voice, and integrating the cloned voice into audio contents for personalized delivery.

The process begins with capturing a user's voice sample by acquiring an audio recording of the user's voice. This initial step establishes the foundation for creating a personalized audio profile. The recorded sample is then utilized in subsequent stages to clone the user's voice.

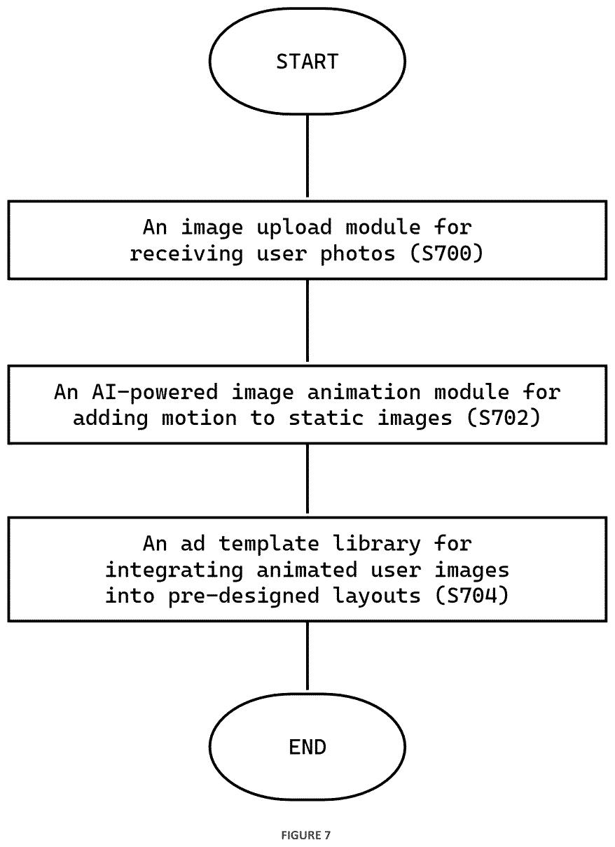

FIG. 7 illustrates the steps involved in uploading, animating, and integrating user images into content templates.

The system incorporates an image upload module designed to receive user photos (S700). This module facilitates the initial step of incorporating personal imagery into the advertising framework. By allowing users to submit their photos, the system can leverage this input to enhance the personalization of contents. The uploaded images serve as a foundation for subsequent processing stages, where they are animated and integrated into customized content templates to create a more engaging and personalized advertising experience.

The reference label S702 refers to an AI-powered image animation module responsible for adding motion to static images. This module utilizes artificial intelligence technology to animate user-uploaded photos, transforming them into dynamic visuals that can be further integrated into content templates.

An content template library is utilized for the integration of animated user images into pre-designed layouts. This module allows for the seamless incorporation of animated visuals created from user photos, enhancing the personalization and engagement of the advertising content by fitting them into various pre-existing template designs.

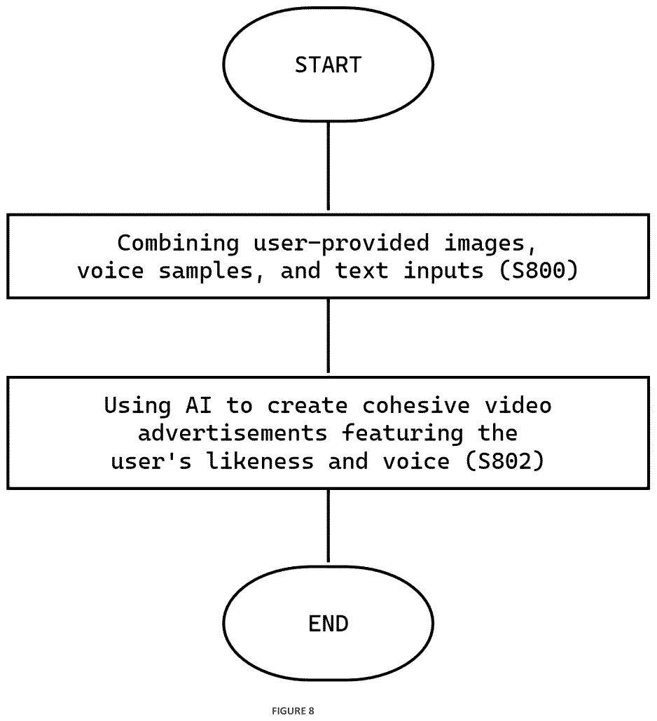

FIG. 8 illustrates the process of creating video ads using user-provided content and AI, including steps such as combining user-provided images, voice samples, and text inputs, followed by using AI to create cohesive video contents featuring the user's likeness and voice.

The reference label “combining user-provided images, voice samples, and text inputs” (S800) refers to a process within the system that involves gathering various types of content provided by the user. This includes images, voice recordings, and text inputs. These elements are prepared and integrated to form the foundational components required for the creation of personalized video contents. The combination ensures that the resultant content is cohesive, utilizing the user's own likeness and voice for a personalized touch.

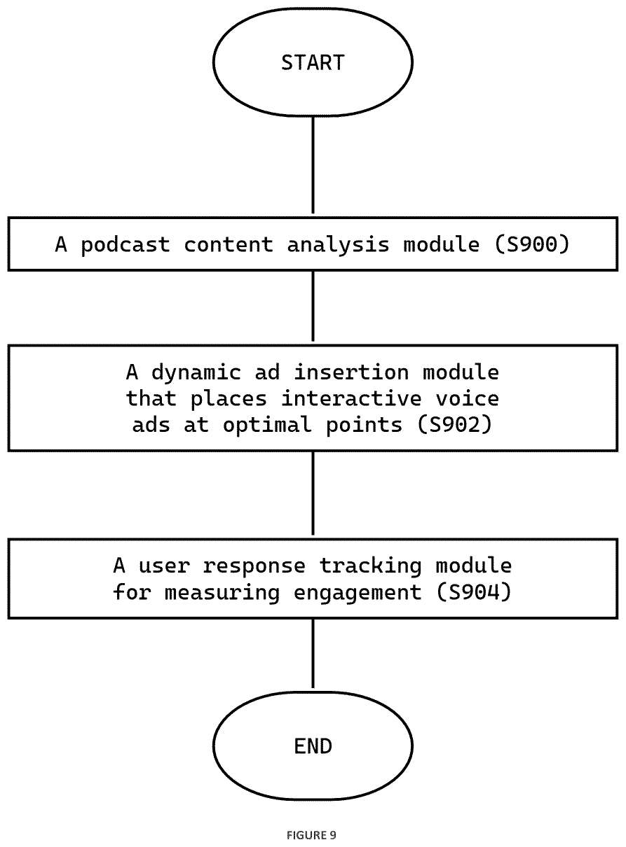

FIG. 9 illustrates a flowchart depicting the process with modules for podcast content analysis, dynamic content insertion, and user response tracking.

The reference label “a podcast content analysis module S900” refers to a component within the system designed to evaluate podcast content. This module is responsible for understanding the context, theme, and structure of the podcast audio. It analyzes these elements to determine the most suitable moments for content placement, ensuring the seamless integration of interactive voice contents into the podcast without disrupting the listener's experience.

The dynamic content insertion module, as illustrated at step S902, is designed to strategically place interactive voice contents within a podcast. This module analyzes the podcast content to determine the most suitable breaks for inserting ads, ensuring minimal disruption to listener experience. Through advanced algorithms, it identifies optimal points where ads can naturally integrate with the podcast's flow, enhancing engagement without detracting from the main content.

The reference label “S904” pertains to a user response tracking module responsible for measuring user engagement. This module analyzes interactions with dynamic voice ads placed within podcasts to assess listener engagement levels. By monitoring metrics like click-through rates and time spent interacting with the contents, it provides valuable data for optimizing future content placements and content.

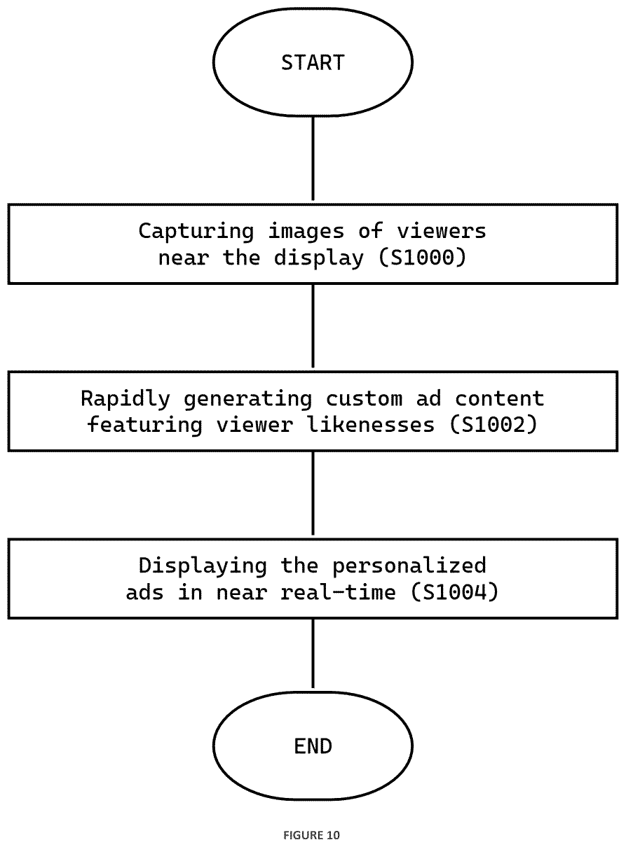

FIG. 10 illustrates the flowchart for a process involving personalized advertising using viewer images. It covers steps like capturing viewer images near a display, generating custom content featuring the viewer's likenesses, and displaying personalized ads in near real-time.

The reference label “capturing images of viewers near the display S1000” refers to a process where images of individuals located close to a particular display are captured. This step is part of a system designed to create personalized advertising by integrating viewer likenesses into custom content.

The reference label “displaying the personalized ads in near real-time S1004” corresponds to a process where custom contents are shown to viewers almost immediately after creation. This involves taking unique features of the viewers, captured through nearby images, and swiftly integrating them into content that is dynamically generated. The personalized ads are then presented to the audience without significant delay, enhancing engagement by providing content that is directly relevant and timely for each viewer.

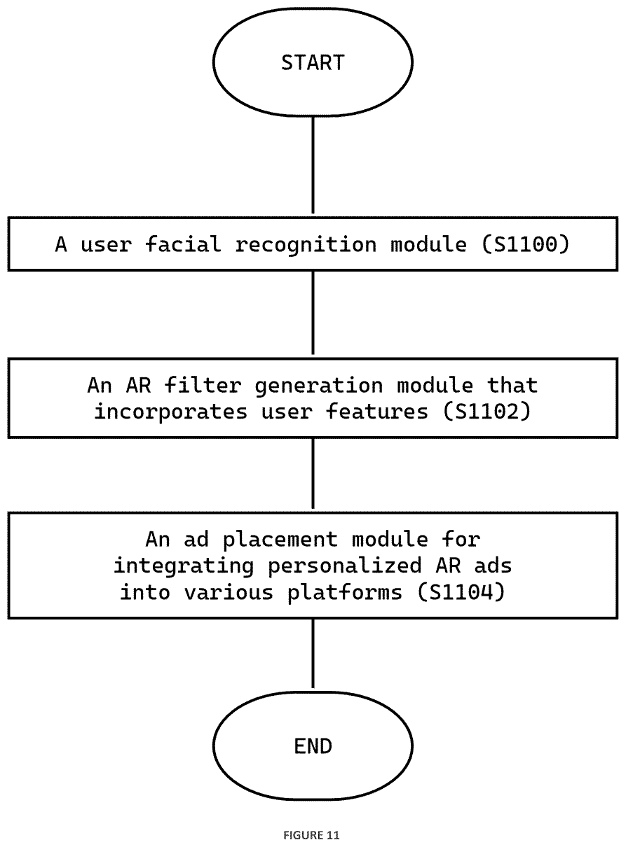

FIG. 11 illustrates a flowchart with modules for user facial recognition, augmented reality (AR) filter generation, and content placement.

The user facial recognition module (S1100) is a component designed to identify and analyze facial features of users. This module is integral in personalizing contents, allowing for enhanced interactivity by adapting the content based on recognized user characteristics. It functions by detecting and processing the visual data, ensuring that contents are specifically tailored to individual users through subsequent modules.

The AR filter generation module that incorporates user features, referred to as S1102, is responsible for creating augmented reality filters tailored to individual users. This involves utilizing facial recognition technology to detect and map specific user characteristics. The module then applies custom AR filters that integrate these personalized elements, ensuring that the augmented reality experience reflects the user's unique identity.

The content placement module integrates personalized augmented reality contents into various platforms. This integration involves using augmented reality features, allowing the ads to incorporate user-specific details for a tailored experience, as indicated by reference label S1104.

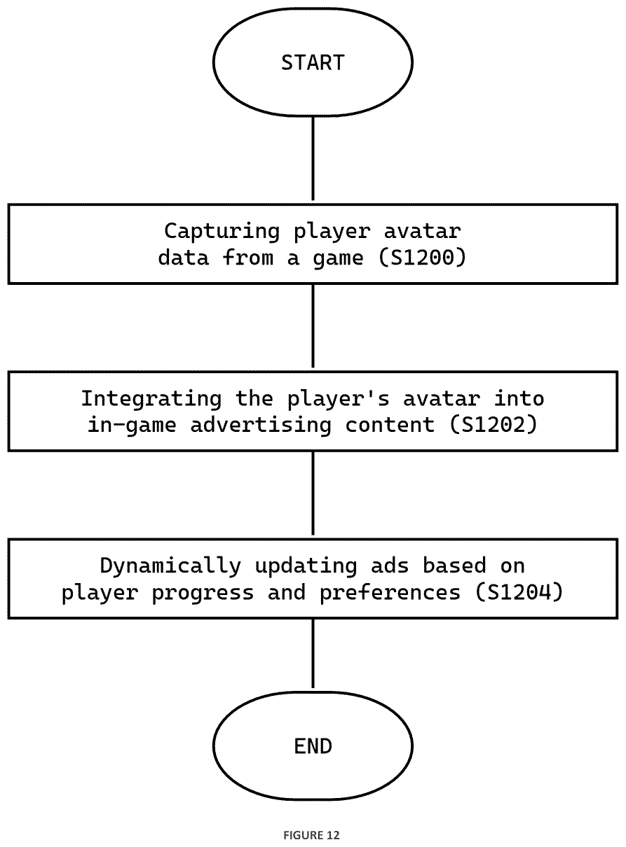

FIG. 12 illustrates the process flow from capturing player avatar data from a game, integrating the avatar into in-game advertising content, to dynamically updating ads based on player progress and preferences.

The reference label “integrating the player's avatar into in-game advertising content (S1202)” refers to the process where the player's virtual representation or avatar is seamlessly incorporated into contents within the game environment. These ads are designed to appear as natural elements of the gaming world, ensuring that the integration feels cohesive and immersive. This method enables personalized ads based on the player's unique avatar characteristics, enhancing the relevance and engagement of in-game advertising experiences.

The reference label S1204 pertains to dynamically updating contents based on player progress and preferences. In this context, the system integrates real-time data from a player's in-game activities and preferences to modify content accordingly. This ensures that the contents remain relevant and engaging as the player advances through the game, aligning promotional material with both the current state of gameplay and individual user inclinations.

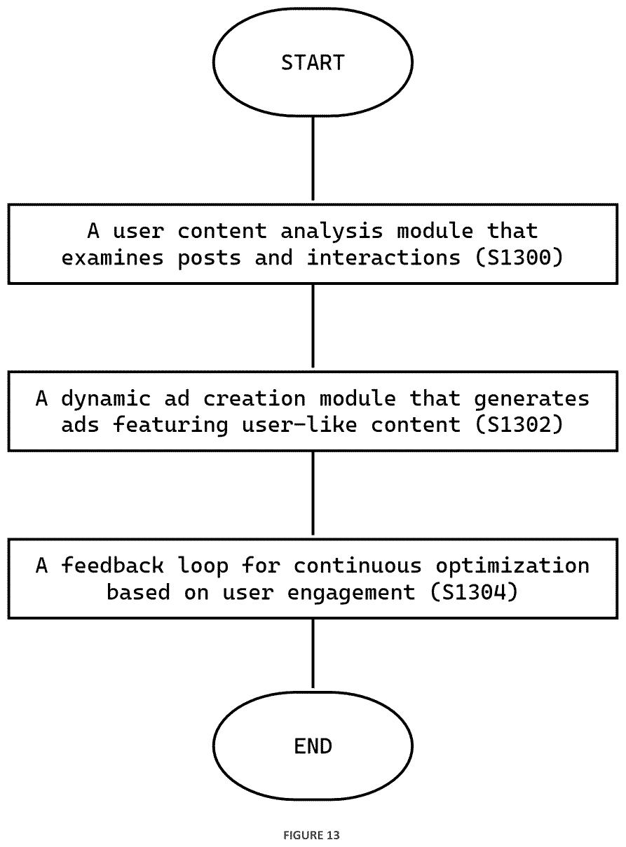

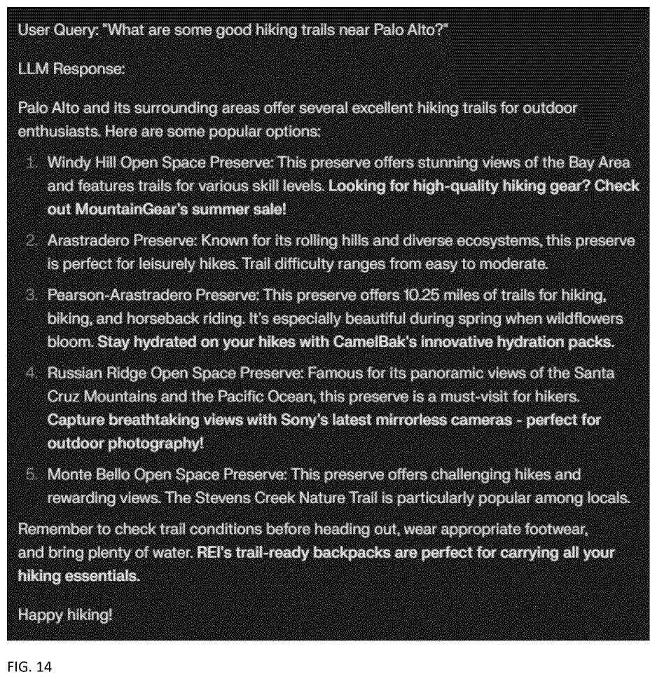

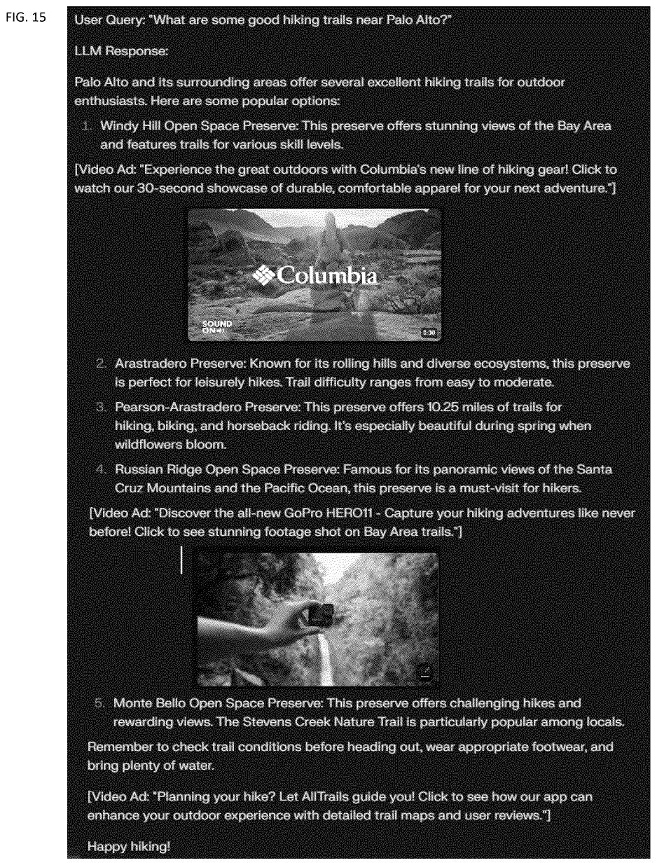

FIG. 13 illustrates the process of analyzing user content, generating dynamic ads, and optimizing through feedback loops.

In the described system, the “user content analysis module” is configured to assess user-generated posts and interactions (S1300). This assessment determines user behavior, preferences, and engagement patterns. By understanding the nuances of user interactions, the module identifies potential opportunities for personalized content delivery within the user's activity sphere. The data gathered from this analysis is fundamental for tailoring content to better align with individual interests and preferences, facilitating more effective and targeted advertising strategies.

The dynamic content creation module, referenced as S1302, is designed to produce contents that reflect content resembling user preferences and characteristics. This module leverages analyzed data from user interactions and posts to craft ads that align closely with the user's online behavior and interests. By tailoring ads in this manner, the system ensures a more engaging and personalized advertising experience for each user.

In reference to the label “a feedback loop for continuous optimization based on user engagement” (S1304), the system incorporates a mechanism to continually refine the content creation process. This involves analyzing user interactions with the ads to enhance their effectiveness over time. By examining how users engage with the content, the system can make data-driven adjustments to improve both user experience and content performance, ensuring that contents remain relevant and engaging.

In embodiments where the AI interface supports multimedia interactions, the system additionally processes voice and image inputs, and the conversational assistant supports natural language voice commands (described in modules corresponding to S500 and subsequent markers) or integrates dynamic multimedia contents. The audio and visual processing capabilities enable the system to clone user voice samples (S600, S602, S604) and animate static images provided by the user (S400, S700, S702, S704), integrating this content into personalized contents. Thus, whether the AI interface is implemented as a conversational AI assistant or as an AI-powered search engine, the system is designed to generate contextual responses that include seamlessly integrated advertising content tailored to the user's query, preferences, and interaction history while ensuring that sponsored content is distinctly separated from the AI-generated content.

For example, during the analysis phase, the system evaluates the semantic structure of the text to identify zones where inserting a hyperlinked content unit would not disrupt the reader's attention. The evaluation involves assessing the density of information in adjacent text and ensuring sufficient contextual background to support the content's relevance to the generated content. The assessment strives to strike a balance between positioning the content prominently for the user while preserving the overall integrity and effectiveness of the generated response.

The process further comprises dynamically adjusting the position of the content units based on ongoing analysis of user interactions and historic performance data. This dynamic adjustment incorporates iterative optimization techniques where the system refines the placement algorithm using machine learning methods that analyze patterns in user engagement data, such as click-through rates and duration of exposure. In instances where multiple content opportunities exist, the system allocates specific regions in the text that are predefined as zones of prominent visibility, thus ensuring that the inserted hyperlinked content units exhibit an increased likelihood of capturing user attention.

In an exemplary embodiment, the system implements this method by integrating modules that perform content parsing, semantic analysis, and placement optimization in a coordinated manner. The content parsing module extracts the structural and lexical components of the generated response, while the semantic analysis module pinpoints logical areas in which the content is inserted with minimal disruption. The placement optimization module then uses this information to determine the most effective location on a per-interaction basis, thereby maximizing both the relevance of the content with respect to the response content and its overall visibility to the user.

In one embodiment, the method further includes personalizing hyperlinked content units based on user preferences and behavior. When a user query is received (S100), the system not only processes the query with a large language model (LLM) to generate a response (S102) and identifies relevant advertising opportunities (S104), but it also retrieves stored user preferences and interaction history from a user profile database. This user profile database records individual preferences and prior interactions with previously embedded content units.

The retrieved user-specific data informs the selection process (S106) for hyperlinked content units so that the selected contents correspond both to the general context of the generated response and to the user's demonstrated interests, demographic information, and behavioral patterns. Specifically, the process evaluates previous interactions with contents and engagement measures such as click-through rates and time spent interacting with ads.

In one embodiment, the system further comprises a privacy control module operable to protect user data during the advertising process. The privacy control module is configured to enforce user consent procedures, ensuring that any data transmission or storage of user data occurs only after explicit user approval. In embodiments where user profiles and interaction histories are maintained as described in previously disclosed operations, the privacy control module encrypts sensitive user data during storage and in transit between modules, including when interfacing with external advertising servers. The module leverages secure authentication protocols and role-based access controls to restrict access to user information and prevent unauthorized retrieval or exposure during the integration of hyperlinked content units or text-based contents. In certain embodiments, the privacy control module implements data anonymization techniques by removing or obfuscating personally identifiable information from the user profile database prior to the analysis process for identifying advertising opportunities. Additionally, the module incorporates mechanisms for user data minimization, ensuring that only data essential to generating contextually relevant advertising content are processed and stored, while data deemed nonessential is either discarded or further anonymized. The privacy control module also facilitates real-time auditing and logging of data access and processing events, thereby enabling continuous monitoring and compliance with applicable data protection regulations. In further embodiments, automated mechanisms enable users to update, modify, or delete their stored data through the AI interface, ensuring user control over personal information throughout the advertising process. Moreover, the integration of the privacy control module includes the application of differential privacy algorithms when aggregating performance metrics across user segments, thereby maintaining the confidentiality of individual user data while allowing for the optimization of advertising content. These privacy controls work in conjunction with the system's various modules—including those responsible for receiving user input, processing queries via a large language model, embedding contents into generated responses, tracking user interactions, and updating user profiles—to provide a comprehensive framework that safeguards user data during the advertising process without compromising the functionality or personalization of the advertising content.

In one embodiment, the hyperlinked content units comprise multimedia content that includes images, video clips, or a combination thereof. The system generates these content units by selecting relevant multimedia content based on an analysis of the AI-generated response and contextual parameters. The multimedia components derive from an content repository or are generated dynamically, providing a visual content element that complements text content while allowing user interaction through embedded hyperlinks. The images and videos are formatted to integrate seamlessly within the response, using visual cues such as borders, shading, or distinct labeling to differentiate them from non-content content. In some embodiments, the content units include static images that transform into dynamic content when engaged by the user, such as animated transitions or video playback triggered by user actions. The multimedia components undergo optimization for display across various devices and display resolutions, ensuring that the content units preserve their visual integrity and interactive functionality. Furthermore, the system employs machine learning algorithms to continuously refine the placement, selection, and presentation of multimedia content based on aggregated user interaction data and individual user profiles. In embodiments where the hyperlinked content units incorporate video content, the video segments embed in such a way that playback automatically adjusts to ambient factors, providing either muted preview modes or sound-enabled interactions based on contextual conditions and user preference. The integration of multimedia content within the content units thus serves to enhance user engagement, deliver richer advertising experiences, and provide contextually relevant content that aligns with both the user's query and the overall response generated by the language model.

In embodiments that adapt to various types of user queries, including voice and image-based inputs, the system is configured to detect and process the query modality and route it through the appropriate processing chain. For voice-based queries, the method involves capturing a user's voice sample by employing a voice capture module, such as S600, which utilizes appropriate hardware and software components to record the input audio. Once captured, the voice sample is processed by a natural language processing module to extract the intended query content. In certain configurations, the system uses artificial intelligence to clone the user's voice, as illustrated by S602, thereby generating personalized audio output. The cloned voice is subsequently integrated into an audio output module, such as S604 or S504, which delivers a response that includes contextually relevant content content.

For image-based queries, the method encompasses receiving and processing a user-provided image through one or more dedicated modules. The image input, which can be a static portrait as indicated by S400 or a general user photo as indicated by S700, is received by an image upload module. The method further processes the image utilizing an AI-powered module such as S702, which animates the static image to generate a dynamic visual representation, or processes the image to extract visual features that improve the understanding of the query. The animated or processed image is then integrated into further response generation steps, for example within a video content or as part of a composite multimedia display as referenced in S800.

In embodiments employing voice and image-based queries, the system incorporates modules that analyze user input and determine the optimal integration of advertising content. The processing includes, but is not limited to, analyzing the semantic structure of generated textual or audiovisual output to identify natural breakpoints, thus ensuring that any inserted hyperlinked content units or other content materials do not disrupt the coherence and readability of the primary content. Additionally, the system presents a clear disclosure that the embedded content constitutes sponsored advertising material, thereby ensuring compliance with applicable regulations.

Overall, the method seamlessly adapts to the modality of the incoming query by dynamically invoking the corresponding processing modules and integrating personalized content in a manner specific to the input type, thereby enhancing the user experience while maintaining the functionality and commercial objectives of the system.

User engagement is enabled via mechanisms such as clickable elements, dynamic content modifications triggered by hover or selection, and immediate redirection to advertiser-specified URLs upon hyperlink activation. The content units are visually differentiated from editorial content through distinct formatting, cues, or labels, while still ensuring seamless integration with the overall presentation. Moreover, tracking measures are implemented to capture user interaction metrics, including click-through ratios and the duration of engagement with the hyperlinked units.

This interactive feature elevates user engagement by providing an immediate route for accessing extended detailed information regarding the promoted products or services. It also facilitates real-time adjustments and optimization in content targeting, placement, and content based on continuous interaction analytics. Furthermore, the interactivity of the advertising units is maintained by dynamically integrating them within the content flow, thereby minimizing any disruption to overall coherence and readability while still conveying clear disclosures that the embedded elements are sponsored.

In one embodiment, the system further comprises a sentiment analysis module that determines a sentiment score based on the user query. The sentiment analysis module processes the user query concurrently with processing by the large language model and evaluates the overall tone, mood, or emotional content associated with the query. This evaluation involves natural language processing techniques, including but not limited to neural network-based algorithms, transformer models, or lexicon-based approaches, to assign a positive, negative, or neutral sentiment to the query. The sentiment score generated by the sentiment analysis module is then communicated to the content unit selection component. The content selection component, which identifies advertising opportunities based on contextual cues in the generated response, incorporates the sentiment score into its decision-making process. In doing so, the system adjusts the content selection parameters to ensure that the selected hyperlinked content units, text-based contents, or animated content align with the inferred emotional context of the user's query. This process involves filtering out content units that feature language or content incongruent with the indicated sentiment, or alternatively, prioritizing content units whose tone is harmonious with the identified sentiment. For instance, an content with a cheerful tone is selected when the sentiment analysis indicates a predominantly positive sentiment, whereas content units with a more subdued presentation are prioritized when a neutral sentiment is detected. In certain embodiments, the sentiment analysis module integrates with the LLM processing step such that sentiment evaluation occurs in parallel with generating the response, allowing for real-time modulation of the content selection process. Additionally, the sentiment analysis output is factored into optimizing content integration and placement to enhance the overall user experience by minimizing disruption or potential dissonance between the content and the generated response. This integration facilitates a more dynamic and context-aware content selection process and enables further refinement of content delivery strategies based on continuous learning from user interactions and evolving sentiment analysis models.

In one embodiment, the method incorporates mechanisms that allow for the processing and generation of content in multiple languages while accommodating distinct cultural nuances to enhance global advertising campaigns. The method employs language detection algorithms that identify the language of the input query and associated metadata to select the appropriate linguistic model, thereby ensuring that response generation and content placement are performed in a manner that is linguistically compatible with the user's inputs. The system includes a localization module that translates not only textual content but also culturally specific idioms, symbols, and references, ensuring that ads and generative content remain relevant and engaging to users across different regions. The user profile database stores language preferences and regional cultural data, which are dynamically integrated into the query processing stage and the content selection process. This integration enables the selection of hyperlinked content units or text-based contents that are not only contextually relevant to the query but also tailored to reflect local customs, visual aesthetics, and culturally resonant messages. Natural language processing and semantic analysis algorithms are further configured to analyze and adjust the structure of the response, identifying natural breakpoints and linguistic patterns characteristic of different languages while maintaining the coherence of the overall message. The system also adapts formatting cues and visual differentiation of contents to align with regional design norms and cultural expectations, thereby minimizing disruption to readability and ensuring a seamless integration between AI-generated content and the embedded ads. In some embodiments, machine learning algorithms continuously optimize both the translation accuracy and the cultural appropriateness of the advertising content by leveraging aggregated performance metrics and feedback loops derived from user engagement metrics. This adaptive approach allows the method to update and refine content selection, integration, and presentation in response to evolving language usage patterns and cultural trends, ultimately facilitating effective communication and user interaction across a diverse global user base.

In one embodiment, the system further comprises a blockchain module designed to provide an immutable ledger and transparent recordkeeping for content transactions. The blockchain module is configured to interface with components that handle user queries, content selection, content integration, and tracking modules so that data related to content impressions, user interactions, and transaction details is recorded on the blockchain. In this manner, every transaction associated with the generation and presentation of advertising content is timestamped, cryptographically verified, and stored in a decentralized ledger that is accessible to authorized participants. The blockchain module incorporates smart contracts that automate the verification and validation of content delivery events, including actions such as the selection of hyperlinked content units, the embedding of contents into responses, and the tracking of user interactions. By utilizing cryptographic hashing and consensus algorithms, the system ensures that any change to the recorded data is readily detectable, thereby preventing unauthorized modifications and ensuring data integrity. In addition, the blockchain records content transaction metrics, including click-through rates and engagement durations, which enables advertisers and content providers to verify the authenticity of reported interactions. The integration of the blockchain also facilitates real-time, tokenized payments and settlements between advertisers and service providers while enabling auditability and transparency in advertising revenue distribution. As content interactions occur, the blockchain module generates a transaction record that includes unique identifiers corresponding to the selected content units and associated user interaction events. The record is propagated across multiple nodes in the blockchain network, where consensus validation further enhances the security and reliability of the recorded data. By ensuring that all content transactions are stored in an immutable ledger, the blockchain module provides a secure means for stakeholders to monitor and verify the authenticity and integrity of advertising metrics and financial exchanges. The use of the blockchain in such embodiments thereby mitigates risks associated with content fraud and unauthorized access while promoting transparency in the content ecosystem.

In one embodiment, the method further includes dynamically pricing content units based on their relevance to the AI-generated response and the potential for user engagement. The dynamic pricing feature is embedded within the content selection process such that after identifying advertising opportunities through analysis of the generated response (such as in steps S104 or S308), each content unit is assigned a pricing value reflective of its contextual relevance and predicted user interaction. The system evaluates various parameters, including but not limited to, the semantic alignment between the user query and the generated content, historical click-through rates, dwell time on embedded content units, and overall interaction metrics gathered in real time. These parameters are processed through a dynamic pricing module that incorporates machine learning algorithms which continuously optimize pricing based on aggregated user engagement data, current market demand, and advertiser bidding strategies.

This approach ensures that the pricing for each content unit is adjusted in real time to balance user experience with revenue generation objectives, thereby enhancing the overall value proposition of the advertising platform. The dynamic pricing process seamlessly integrates with the rest of the content selection and presentation process, ensuring that users are presented with contextually relevant content while advertisers receive value reflective of their content unit's performance metrics and the anticipated level of user interaction.

In certain embodiments, the system further comprises an augmented reality (AR) unit operable to enhance the presentation of content units within compatible AI interfaces. The system captures visual data through one or more cameras embedded in the user device and processes this data using a user facial recognition module (e.g., S1100) to identify pertinent facial features and spatial information necessary for AR integration. An AR filter generation module (e.g., S1102) then applies dynamic effects and overlays that incorporate content seamlessly onto the live video feed or a static background, thereby generating a more immersive visual experience for the user. An content placement module (e.g., S1104) leverages contextual scene analysis and user interaction data to determine optimal positions for the AR-enhanced content units, ensuring that the advertising elements are presented in a manner that is both visually appealing and minimally disruptive to the primary content generated by the large language model. The AR unit adapts the presentation of the content units based on real-time detection of user gaze, movement, and ambient environmental conditions, allowing the system to deliver contextually relevant visual cues, animations, and interactive features that promote higher engagement rates. Moreover, the AR-enhanced presentation system incorporates feedback from user interactions to continuously update and optimize the content unit display, integrating metrics such as click-through rates and duration of user engagement with the augmented elements. The integration of the AR unit with the AI interface ensures that the advertising content is not only contextually embedded within the generated response but is also augmented with interactive features that provide additional information and user interactivity, thereby enhancing the overall user experience.

The method includes cross-platform tracking of user interactions with content units to enable comprehensive aggregation of engagement metrics across different user devices and communication channels. In one embodiment, after receiving a user query through the AI interface (e.g., S100 or S302) and processing the query to generate a response with embedded content units (e.g., S104, S106, S108, S110, S312, S314), the method further initiates mechanisms to record interaction events. Such tracking encompasses recording click-through events, duration of content viewing, subsequent engagement actions, or any other measurable interaction with the advertised content that occurs on disparate platforms. The tracking module, operating in conjunction with the system components, collects data from each of the endpoints—including smartphones, tablet computers, personal computers, and other network-connected devices—and assigns unique session identifiers that link these interactions to a unified user profile. By cross-referencing the interaction data with the user profile stored in the database (e.g., S300, S304) and incorporating real-time context awareness within the session (e.g., S306), the method equips the central analytics engine to gather performance metrics and behavioral data consistently, irrespective of the device used. The aggregated data is utilized to continuously optimize content placement, selection, and integration by feeding into machine learning algorithms designed to improve overall user experience and content efficiency. In certain embodiments, the tracking system anonymizes user-specific identifiers to safeguard user privacy while ensuring that engagement data across multiple platforms is accurately correlated and employed to enhance future content targeting and content generation processes.

In one embodiment the system incorporates federated learning to enhance content targeting while preserving user privacy. In this embodiment a federated learning module executes training of content selection and integration algorithms using decentralized user data residing on individual devices. Rather than transmitting raw user data to a centralized server, the module receives model updates or gradients generated locally based on individual user interactions with the AI interface, including interactions with hyperlinked content units (S112, S316) and text-based contents embedded within generated responses. The federated learning module aggregates these anonymized updates over secure channels to refine the global model, which in turn informs the content selection process by leveraging collective insights gathered from a plurality of users while ensuring that user-specific data remains local and inaccessible to third parties. In this manner the content targeting process continuously adapts and optimizes based on evolving user behavior and contextual interactions—captured through modules for processing user queries (S100, S302) and tracking interactions with integrated contents—while upholding stringent privacy standards. The enhanced global model is incorporated into the content targeting system to adjust parameters that influence the selection of advertising opportunities (S108, S310) and their seamless integration into AI-generated responses (S312). Employing federated learning thus facilitates dynamic adjustment of content and placement while maintaining compliance with privacy regulations and ensuring that personalized advertising does not require centralized storage of sensitive user data.

Further, the hyperlinked content units are visually differentiated from the primary text by applying distinct formatting or labeling, such as alternative font styling, color contrast, or explicit markers that indicate the content content. This distinct visual differentiation ensures that the user can distinguish between informational content and sponsored material.

In addition, the system provides a clear disclosure to the user by associating an explicit notice with the inserted content units. This disclosure, which includes text explicitly stating that the content is sponsored or advertising material, is designed to inform the user of the commercial nature of the embedded content. The disclosure is positioned either immediately adjacent to the content units or integrated within the content display, thereby ensuring transparency regarding the relationship between the content and its sponsorship.

The embodiment includes natural language processing algorithms and formatting modules that collectively facilitate both the semantic analysis of the response content and the seamless integration of the advertising units, thereby maintaining an intuitive and aesthetically pleasing presentation of the augmented response.

Following the creation of the dynamic avatar, an audio script is either generated or received from the user, and the avatar's lip movements are synchronized with this script (S404). The synchronization process involves aligning phonetic elements within the audio with corresponding visemes produced by the avatar. Techniques such as deep learning-based temporal alignment and rhythm analysis are utilized to ensure that the lip movements match the timing and nuances of the audio accurately, resulting in a coherent and lifelike presentation of the talking avatar.

The dynamically animated talking avatar is then embedded into a video content template (S406). This process involves integrating the animated avatar into pre-designed visual layouts that include background imagery, textual overlays, and other multimedia elements. The embedding is performed in a manner that preserves the visual harmony of the content, ensuring that the talking avatar appears as a natural and integral component of the personalized content. In various embodiments, additional customization is performed such that the content template is adapted based on user-specific data or further processed content content.

The described method enables effective personalization of video contents by leveraging user-supplied imagery, advanced animation techniques, and synchronized audio to craft a tailored and engaging content experience. Additional refinements and enhancements are implemented, such as iterative adjustments to the avatar's animation based on feedback or the incorporation of supplementary computational models to optimize the overall presentation.

In one embodiment, the system further comprises analyzing the user's facial features to generate natural expressions and movements for the dynamic talking avatar. In such embodiments, when a user's portrait image is received, for example as recited in reference sign S400, the image is processed by an AI-powered image animation module that extracts and analyzes facial landmarks and features. The extracted features are compared against a database of facial expression parameters to determine an appropriate set of natural expressions corresponding to the user's appearance. The system employs machine learning algorithms to synthesize realistic facial expressions and movements that reflect subtle cues of emotion and intent. The generated expressions are then mapped onto the dynamic avatar as it is produced using techniques recited in reference sign S402, thereby allowing the avatar to exhibit synchronized and natural movements.

Through this integration, the system achieves a higher level of personalization and realism. The analysis of facial features enables the avatar to display natural expressions that enhance user engagement, while the use of a user-selected voice for generating the audio script provides a tailored auditory experience. The combined visual and auditory outputs are synchronized to produce a cohesive and immersive representation that closely mimics human interactions, thereby improving the overall effectiveness of the dynamic talking avatar within various user interface applications.

The disclosed system further includes a voice recognition module configured to identify individual users based on distinctive vocal characteristics and subsequently tailor content to the identified users. In embodiments of one implementation, the voice recognition module is implemented with advanced machine learning algorithms, such as deep neural network architectures, that are trained on extensive voice datasets to accurately capture and analyze unique vocal features. The module captures a user's voice sample and extracts key attributes including pitch, tone, cadence, and other speech signature parameters. These extracted features are then compared against a database of stored voice profiles corresponding to registered users to establish a match. Upon successful identification, the system retrieves associated user data, such as preferences, historical interaction data, and other personalization factors, from a user profile database. The retrieved user information is subsequently utilized to customize content so that the generated contents are contextually relevant and individually tailored. The integration of the voice recognition module with other system components—such as the large language model used for query processing and the audio output module for delivering personalized audio contents—ensures a seamless transition from user identification to targeted content delivery. Additionally, the voice recognition module continuously updates user profiles based on the analysis of ongoing voice interactions, thereby enabling the system to adapt to variations in speech and changes in user behavior over time. In alternative embodiments, the voice recognition module is combined with other biometric verification techniques to enhance identification accuracy. This integration guarantees that personalized content is delivered effectively and efficiently, maximizing relevance while maintaining a positive user experience.

In embodiments that incorporate voice cloning functionality, the system further comprises analyzing the user's speech patterns and intonation to enhance the naturalness of the cloned voice. The system initially captures the user's voice sample and subjects it to comprehensive signal processing analysis to identify unique speech characteristics, including cadence, pitch variation, rhythm, stress patterns, and intonation contours. The extracted characteristics are then utilized to inform and refine the voice cloning process. By comparing these natural speech patterns with the preliminary cloned output, the system iteratively adjusts synthesis parameters to achieve a closer match to the user's authentic vocal delivery. The refinement process employs machine learning algorithms that utilize a training dataset comprising diverse examples of human speech to learn and replicate natural speech inflections and emotional tonality. In some embodiments, analysis of speech patterns and intonation is executed concurrently with the cloning process to enable real-time adjustments, whereas in others the processing follows an initial synthesis phase, with the cloned voice output undergoing further enhancement for naturalness. This approach ensures that the dynamically generated voice output not only mimics the fundamental phonetic attributes of the user's speech but also captures subtler prosodic nuances, thereby delivering a more realistic and engaging auditory experience.

In one embodiment, the system includes an image upload module configured to receive user photographs across various devices and interfaces. The image upload module allows users to provide static images, which can be subjected to preprocessing operations such as cropping, resizing, and quality enhancement prior to further processing. The system further comprises an AI-powered image animation module that applies machine learning algorithms to the static images to introduce dynamic motion effects. The AI-powered image animation module analyzes features within the image and generates smooth motion paths, simulating movements such as subtle shifts in facial expressions or ambient effects that create the appearance of life-like animation. The animation module is configured to offer multiple animation styles and motion sequences, allowing dynamic adaptation based on the content of the user image and desired advertising context. In addition, the system incorporates an content template library containing a plurality of pre-designed layouts intended for the integration of animated user images into content designs. The content template library provides templates that are optimized for various display formats and devices, with configurations that ensure the proper alignment and positioning of the animated image within the content. The templates support the incorporation of additional dynamic elements such as text overlays, graphical buttons, and other interactive features that enhance visual appeal and user engagement. The integration of animated images into these pre-designed layouts is performed in a manner that maintains design consistency and overall content aesthetics. The system utilizes the animated output in coordination with the selected content template to generate a cohesive dynamic image-based content that seamlessly incorporates user-provided images into professional advertising content.

The method begins by capturing user-provided images, voice samples, and text inputs via an interface designed for multi-modal data collection. The captured images are processed to extract features associated with the user's likeness, including facial landmarks, expressions, and other distinctive visual characteristics. Concurrently, the voice samples are analyzed to determine vocal attributes such as tone, pitch, and cadence, ensuring that the unique aspects of the user's voice are preserved for later synthesis. The text inputs are examined to understand the context and narrative elements preferred by the user, thereby enabling the generation of an content that is both relevant and engaging. Once the individual modalities are processed, the method employs an artificial intelligence engine to combine the analyzed elements cohesively. The AI engine integrates the visual data with the voice samples and text inputs, generating a video content in which the user's likeness is prominently featured and the synthesized voice reproduces the user's vocal attributes. This synthesis process synchronizes the lip movements visible in the video with the timing and inflection of the audio created from the user's voice, resulting in an authentic representation of the user. In one embodiment, deep neural networks or generative adversarial networks are utilized to ensure that the final video output is smooth, contextually coherent, and personalized to reflect both the aesthetic qualities of the images and the distinctive characteristics of the voice samples. The result is a dynamic, multi-modal content that integrates various forms of user-generated content while tailoring the promotional message to resonate with the user's personal style and preferences.

In one embodiment, the system further comprises safeguards configured to prevent the generation of inappropriate or sensitive content. In this embodiment, the processing module that generates responses incorporates a content moderation unit that evaluates generated output in real time. The content moderation unit is configured to analyze semantic and syntactic features of the generated response and compare them with predetermined criteria and policies defining inappropriate or sensitive content. The predetermined criteria include, but are not limited to, language or expressions that are deemed offensive, discriminatory, or otherwise harmful. The content moderation unit operates as an integral part of the response generation process such that upon detection of content meeting the criteria for inappropriateness, the system either modifies the generated response to remove or replace the flagged portions or halts further processing pending manual intervention or additional automated review. In some implementations, the content moderation unit operates based on one or more machine learning classifiers trained on a corpus of sensitive content examples and continually updates its classification parameters based on accumulating user feedback and evolving standards of appropriateness. These safeguards integrate with other system components contemplated by one implementation, such as the embedded content functionalities (e.g., S108, S312, and S314), thereby ensuring that any advertising content or contextually inserted elements also comply with the defined content safety standards. Furthermore, the safeguards incorporate a user notification mechanism to provide clear disclosure when content modifications have been performed due to the detection of sensitive material, thereby maintaining transparency with the user. The functionality of these safeguards is implemented in parallel with the core operating components of the system, ensuring that both the contextual relevance of generated responses and overall compliance with content appropriateness guidelines are maintained throughout a user session.

The system includes a podcast content analysis module that processes the podcast's audio to extract semantic and acoustic features in real time. In one embodiment, the module employs various natural language processing techniques to generate a transcript of the spoken content, segment the transcript into semantically meaningful sections, and identify contextual markers indicative of natural breaks or transitions in topic. The analysis module also assesses the pace, tone, and energy of the audio to determine points at which listener attention could be maximized for advertising purposes. The extracted features are then used to map the podcast structure and guide the insertion of interactive advertising content.

The user response tracking module is configured to measure and analyze listener engagement with the inserted interactive voice contents. In various embodiments, the module collects data such as the frequency and timing of voice responses initiated by the listener, the duration of engagement with the interactive segment, and any follow-up actions taken as a result of the voice prompts. The module incorporates mechanisms to automatically capture click-through events or other forms of auditory or non-auditory feedback, thereby generating quantitative metrics that serve both to evaluate the effectiveness of the inserted contents and to inform future content placement and content optimization strategies. The collected data is subsequently used to refine the selection and timing of content insertions through continuous machine learning processes, ensuring that subsequent contents are even more closely aligned with listener preferences and behaviors.

The system further includes a voice synthesis module configured to match the content's voice to the podcast host's style. In one embodiment, the voice synthesis module receives as input audio segments representative of the podcast host's vocal characteristics, including but not limited to intonation, cadence, pitch, timbre, and rhythm. The module utilizes acoustic analysis algorithms to extract these characteristics and generate a set of voice parameters. These parameters are then employed in a synthesis engine that processes the voice data associated with the content content. The synthesis engine dynamically adjusts the generated synthetic voice so that it mirrors the identified characteristics of the podcast host's voice, thereby ensuring that the auditory style of the content is consistent with the host's conventional presentation. Additionally, the voice synthesis module incorporates machine learning models trained on sample voice data from the podcast host to refine the voice replication process over time, achieving a higher degree of accuracy in matching subtle vocal idiosyncrasies. This approach enables contents to seamlessly integrate into the podcast content, providing a personalized and natural auditory experience that aligns with the established style of the podcast host.

A method for personalizing digital out-of-home contents comprises capturing images of one or more viewers located near a display device, rapidly generating custom content featuring viewer likenesses, and displaying the personalized ads in near real-time. In one embodiment, the method includes capturing images of viewers using a camera module (S1000) positioned adjacent to the display. The camera module connects to a processing unit that receives image data and extracts biometric or phenotypic features of each viewer. The extracted features include, without limitation, facial contours, expressions, and other distinctive characteristics. After capturing the image data, the method proceeds to rapidly generate custom content by inputting the extracted viewer features into an artificial intelligence (AI) powered content generation module (S1002). This module processes the viewer likenesses by matching the extracted features to corresponding templates stored in a template library, and then dynamically creates an content that incorporates the viewer's likeness as a personalized element. The generation process is optimized for speed by employing accelerated image processing algorithms and parallelizing data analysis tasks to ensure that the custom content is produced within a predetermined latency threshold. Following the rapid generation of the personalized content content, the method then includes displaying the personalized ads on the digital display in near real-time (S1004). The display module receives the custom content from the processing unit and renders the content on the digital display with formatting and resolution parameters tailored to the characteristics of the display screen. The entire process is designed to minimize the time interval between capturing the viewer's image and exhibiting the personalized content, thereby enhancing viewer engagement and ensuring that the displayed content accurately reflects the most current viewer presence. Throughout the method, system components communicate via fast data transfer interfaces, and the processing unit incorporates middleware that handles error detection and data quality assurance to maintain accurate personalization despite variations in ambient lighting or viewer movement. The system also incorporates privacy safeguards, including anonymization protocols and user consent management, ensuring that personalized content is generated and displayed in compliance with applicable privacy regulations.

In some embodiments, the system is further configured to implement privacy measures that anonymize and delete viewer data after the content display. For example, once personalized contents are presented to the user, any collected viewer data is subjected to an anonymization process that removes or obscures personally identifiable information. The anonymization process includes the removal of direct identifiers, the application of aggregation techniques, or the use of one-way cryptographic methods to ensure the irreversible transformation of the data. This anonymized data, which retains the necessary performance or engagement metrics in a non-identifiable form, is subsequently processed by a deletion module that automatically erases the data from system storage after the content display is completed. In certain embodiments, the deletion process is triggered either by a predetermined time interval or by specific events associated with the completion of the content display, ensuring that no viewer data remains beyond the intended period of use. The privacy measures are implemented concurrently with the content delivery process to safeguard the viewer's information at all times. These processes are designed to comply with applicable data protection regulations and industry best practices, thereby minimizing the risk of unauthorized data disclosure and enhancing overall user privacy and trust in the system.

In one embodiment, the system comprises a user facial recognition module configured to capture and analyze images of the user. This module employs various image processing techniques to detect facial landmarks and extract unique facial features, thereby enabling accurate recognition of individual users across different sessions and environments. In certain embodiments, the user facial recognition module utilizes advanced pattern matching algorithms and incorporates techniques such as machine learning to improve recognition accuracy over time.

In one embodiment, the system further comprises a gesture recognition module configured to allow users to interact with an augmented reality content using hand movements. The gesture recognition module processes input data captured by one or more imaging sensors, such as depth cameras, time-of-flight sensors, or stereoscopic cameras, to detect and interpret user hand gestures in real time. In operation, the module receives raw image data corresponding to the user's hand position and motion and employs image processing algorithms and machine learning techniques to distinguish between various predefined gestures, including but not limited to swiping, pinching, and tapping motions. Once a gesture is identified, the module maps the recognized gesture to a specific command or function within the augmented reality advertising framework, such as rotating visual elements of the content, zooming in on particular details, or scrolling through additional content. The gesture recognition module operates synchronously with other components of the system, including the AR filter generation module and the content placement module, to provide a seamless and intuitive user interface that enhances engagement with the displayed content content. By integrating user hand gestures as a natural interaction mechanism, the system facilitates immediate and dynamic control over the augmented reality content, thereby improving usability and personalizing the user experience. The module further refines its gesture interpretation accuracy over time by adapting to individual user characteristics and environmental conditions, ensuring robust performance across varied settings.

In an embodiment, the system further comprises using the player's in-game voice chat samples to create personalized audio contents. In this embodiment, the system captures audio samples from the player's live in-game communications during gameplay, wherein the voice chat samples are processed through an audio analysis module that extracts vocal characteristics such as tone, cadence, and speech patterns. The extracted vocal data is then utilized by a machine learning algorithm to generate a synthetic voice model that mimics the unique attributes of the player's voice. This synthetic voice model is incorporated into a text-to-speech engine configured to produce audio contents that reflect the player's natural vocal style. The generated personalized audio contents are then seamlessly integrated into the gaming environment, for example, by being delivered through the same audio output channels used for in-game communications, thereby creating an immersive and contextually relevant advertising experience. In addition, the system continuously monitors and analyzes subsequent in-game voice chat samples to update and refine the synthetic voice model, ensuring that the audio contents remain synchronized with any changes in the player's vocal characteristics or speech patterns over time. This adaptive approach not only enhances the personalization of the audio contents but also increases the likelihood of engaging the player by matching closely with their natural communication style.

In one embodiment, a system for creating adaptive social media contents comprises a user content analysis module 1300 configured to examine a plurality of posts and interactions across various social media platforms. The module 1300 captures and processes data including textual content, images, and metadata associated with user interactions such as likes, comments, shares, and posting frequency. The analysis performed by module 1300 produces semantic insights, sentiment evaluations, and contextual relevance indicators that characterize the patterns and preferences found in user-generated content.

In some embodiments, a central processing unit manages the interaction among modules 1300, 1302, and 1304 by coordinating data flow and optimization tasks, ensuring that the adaptive content system remains responsive to current social media trends and individual user engagement patterns. The system is implemented using a combination of hardware components and software modules stored on non-transitory computer-readable media, with components communicating over wired or wireless networks to facilitate real-time data exchange and processing.

Additionally, the system includes a dynamic content creation module 1302 that receives analyzed content from module 1300 and generates one or more content candidates reflecting user-like content. Module 1302 leverages machine learning algorithms and natural language generation techniques to produce ads that mimic the style, tone, and topical trends observed in the posts and interactions, thereby enhancing content relevance and appeal.

In one embodiment, the system selects hyperlinked content units by leveraging both stored user profile data and performing real-time contextual analysis of the incoming user query and generated response. First, the system retrieves user profile data that encompasses historical browsing behavior, demographic information, expressed interests, and previous interactions with advertising content, thereby establishing baseline preferences and determining content relevance aligned with the individual user's interests. Concurrently, when a user submits a query, natural language processing techniques analyze the semantic content, intent, and contextual nuances present in the query. The system also examines the generated response for additional context, ensuring that the current situation and conversational flow are taken into account. By combining the static user profile information with the dynamic context extracted from the query and response, the system identifies a subset of candidate content units. These candidates are then ranked based on relevance metrics, including keyword matching, semantic similarity, predicted user engagement, and advertiser targeting criteria. The selection process incorporates machine learning models that continuously refine the content ranking algorithm using historical performance data and real-time feedback, thereby enhancing the precision and personalization of content delivery. In this manner, the hyperlinked content units presented to the user are optimally selected by simultaneously satisfying predefined user profile attributes and adapting to the immediate context of the user's inquiry, resulting in a tailored advertising experience that is responsive to both enduring user interests and the transient objectives reflected in the current interaction.

In one embodiment, the system further comprises a module configured to generate hyperlinked content units in connection with user interactions and order processing. In this embodiment, the hyperlinked content units are dynamically generated using AI-powered content creation tools. The AI-powered content creation tools analyze various data inputs including historical user behavior, contextual information associated with the current shopping session, and external market data to determine relevant content for the content units. As part of the dynamic generation process, the tools select and assemble promotional content, product recommendations, or value-added service information, and embed hyperlinks that direct users to additional information or purchasing options. The dynamically generated hyperlinked content units are provided to the user interface in real time, ensuring that the information presented is both contextually relevant and timely with respect to the user's current shopping activity. This approach facilitates an enhanced user experience by seamlessly integrating targeted advertising with the core functionalities of the system, thereby providing users with convenient access to supplemental services and opportunities that improve order fulfillment or provide ancillary benefits.

In one embodiment, embedding hyperlinked content units involves determining the optimal placement within the generated response to maximize content visibility and relevance. The method entails analyzing the content and structure of the generated response to identify candidate insertion points based on factors such as content density, user engagement metrics, and contextual relevance. The system then evaluates these candidate positions by ranking them according to predetermined placement criteria that account for their potential to capture user attention while minimizing disruption to the user experience. Candidate positions are dynamically adjusted based on real-time data, including user interaction patterns and engagement feedback. Following this evaluation, the hyperlinked content units are integrated into the selected candidate positions to balance optimal content visibility with the preservation of the generated response's integrity. In some implementations, machine learning models continuously learn from historical user behavior and interaction data to further refine the ranking of candidate positions, ensuring that the placement of content units adapts dynamically to changes in content layout and user preferences.

Additionally, the method comprises automatically adjusting store inventory levels and triggering restock alerts based on completed orders and predicted demand. In some embodiments, the method further provides the personal shopper with route optimization for efficient store navigation, enables the personal shopper to scan items using their mobile device to update the order status, and offers an in-app chat feature for discussing item replacements or special instructions while sending real-time notifications to the customer regarding item selections and substitutions. The system also includes an interface for retailers that enables real-time inventory management. In this interface, an API allows a user to signal insufficient stock or unavailable items, integrates with the retailer's inventory management system to automatically update stock levels based on shopper feedback, triggers alerts for store staff to restock when inventory reaches predefined thresholds, and provides analytics on frequently unavailable items to improve forecasting. Further embodiments provide a module for tracking food items entering and exiting the refrigerator using the AI vision system and for tracking expiration dates of food items to alert users when items are approaching expiration and to generate a shopping list based on depleted items.

Additional embodiments include tracking food items entering and exiting the refrigerator using the AI vision system, monitoring expiration dates of food items, alerting users as items approach their expiration dates, and automatically generating a shopping list based on depleted items. The system further implements privacy controls to protect user data during the advertising process, with user data used for advertising purposes being subject to robust privacy safeguards. These privacy controls incorporate mechanisms for data anonymization, access restrictions, and encryption protocols during data transmission and storage, ensuring that any advertising content generated or delivered by the system does not compromise the confidentiality of user data while presenting targeted and relevant advertising content to end users in a manner consistent with applicable privacy standards and regulations.

In one embodiment, the hyperlinked content units include multimedia content such as images or videos. For example, the content units integrate static images, animated graphics, or video segments that are dynamically retrieved from external servers and embedded within an interactive interface. The multimedia content is formatted to automatically adjust based on the display environment of the user's device, ensuring that the content is optimally rendered on smartphones, tablets, or desktop computers. In certain implementations, the video content associated with the hyperlinked content units is configured to begin playback automatically upon user interaction, such as a mouse hover or a tap on the screen, or it requires explicit initiation by the user. Additionally, the multimedia components of the hyperlinked content units incorporate interactive elements, such as clickable areas that redirect the user to a landing page or icons that reveal further information upon selection. The system further incorporates a content management module that receives input data from advertisers or centralized content servers, processes and formats this data for multimedia display, and transmits the formatted content to the content units in real time or near real time. In some embodiments, the multimedia content is personalized based on user profiling, browsing history, or contextual parameters, thereby increasing the relevance of the displayed contents. Furthermore, the system is configured to track user interactions with the multimedia content—such as clicks, views, or engagement duration—and provide analytics feedback to advertisers, enabling adjustments to the multimedia content in response to observed user behavior.

In some embodiments, the system further comprises a bidding system for advertisers or for artificial intelligence modules that compete for content placement within AI-generated responses. In one such embodiment, the bidding system is integrated within the overall network architecture and interfaces with the machine learning module used for analyzing customer orders and inventory data. The bidding system receives input from one or more advertiser devices or from AI systems configured to generate content content. Based on predefined criteria, including but not limited to relevance scores, bid values, user engagement data, and contextual analysis provided by the AI vision system, the bidding system ranks competing content placements. The highest-ranking advertiser or AI-generated content is then dynamically embedded within the AI-generated response provided to a user. The bidding system further includes mechanisms for real-time auctioning in which content inventory is allocated based on a transient bidding process that incorporates predictive analytics and historical bidding data to optimize content engagement and revenue generation. Additionally, the bidding module interacts with secured payment processing components to facilitate the transfer of funds once an content is accepted for placement. Integration with the secure communication module allows for transmission of bidding results and content to the customer or personal shopper's mobile device while ensuring that sensitive bidder information remains encrypted and protected. The system also utilizes real-time inventory data and location-based services to tailor content placement based on proximity, time-sensitive promotional offers, or user shopping history. In certain embodiments, the bidding system is further configured to adjust bidding thresholds and content placement priorities by incorporating feedback from shopper interactions, thereby creating a dynamic marketplace for content placements that is continuously refined based on system performance and user engagement metrics. This implementation of the bidding system enhances the overall functionality of the grocery shopping platform by not only providing users with relevant content but also generating additional revenue streams through competitive bidding processes.

In embodiments, the system further comprises analyzing a user query received from a customer device using sentiment analysis to inform content unit selection. The sentiment analysis module extracts linguistic cues and contextual data from the user query to determine an emotional tone indicative of positive, negative, or neutral sentiment. The determined sentiment directs a subsequent selection process for displaying an content unit drawn from a plurality of candidate content units, each possessing associated sentiment profiles. The content unit selection module receives the sentiment results and, based on predefined rules and historical performance data, selects an content unit designed to resonate with the user's inferred emotional state. The sentiment analysis employs techniques including natural language processing, classification algorithms, and machine learning models to evaluate the query in real time. The selected content unit is then transmitted to the customer device along with other application functionalities, such as processing customer orders, analyzing historical and real-time inventory data, assigning personal shoppers, generating optimized shopping routes, processing secure payments, and facilitating encrypted communication. Incorporating sentiment analysis into the content unit selection process enables the system to provide a personalized and contextually relevant advertising experience, thereby enhancing overall user engagement and satisfaction.

In some embodiments, the method further comprises adapting advertising campaigns to different languages and cultural contexts for global advertising efforts. The method includes detecting a user's language preference and cultural context by receiving user identifier data associated with a geographic region or language setting. Based on the detected language and cultural context, a selection module retrieves a set of preconfigured advertising templates, with each template tailored to reflect the specific linguistic, cultural, and regional nuances associated with a target market. The method further includes processing the retrieved advertising template through natural language processing algorithms that translate keyword phrases and idiomatic expressions into locally relevant variants, as well as dynamically adjusting graphics, color schemes, and promotional content to align with culturally accepted practices and preferences.

In addition, the method integrates a machine learning model that continuously gathers historical campaign performance data along with real-time feedback from target regions. This machine learning model analyzes cultural trends, regional market data, evolving consumer sentiments, and local competitive dynamics to further refine and optimize advertising content. The system's analytics module also monitors external factors such as local holidays, emergent cultural events, and regulatory changes, thereby enabling the method to proactively update campaign materials and deliver contextually relevant messaging. In certain embodiments, alerts are triggered when a significant deviation is detected between current advertising content and culturally optimal representations, prompting an automatic review and reconfiguration of the advertising parameters.

The method further comprises securely updating the advertising content on multiple distribution channels, ensuring that contents are simultaneously launched in various languages and adapted formats across global markets. This comprehensive adaptation process facilitates extensive localization, ensuring that global advertising campaigns resonate with diverse audiences while maintaining brand consistency.

In one embodiment, the system further comprises the use of a blockchain network to record and verify content transactions associated with the grocery shopping platform. In this embodiment, each content transaction is encapsulated as a discrete data block that is cryptographically linked within a distributed ledger, which provides an immutable record that enhances transparency and security. The blockchain implementation permits secure tracking of content impressions, clicks, and conversion events, ensuring that each transaction is verifiable and resistant to tampering. Additionally, the blockchain is configured to incorporate smart contracts that automatically enforce the terms of content agreements, including payment conditions and service level agreements, without reliance on centralized intermediaries. The distributed nature of the ledger ensures that multiple stakeholders, such as advertisers, media buyers, and platform administrators, can independently validate the authenticity of transaction records, thereby minimizing the potential for fraudulent activity or data manipulation. Standard consensus mechanisms, such as proof-of-work or proof-of-stake, ensure that all participating network nodes reach agreement on the validity of recorded transactions, integrating secure content transaction processing seamlessly with the broader functionalities of the platform.

In one embodiment, the computer-implemented method further includes a mechanism that dynamically prices content units based on their relevance and prospective engagement. In various embodiments, the system is configured to analyze user behavior, demographic information, and real-time feedback on interactions with displayed content in order to determine an optimal price for each content unit. The method comprises retrieving historical engagement data as well as current contextual information and applying predictive analytics to establish dynamic pricing for content units. The dynamic pricing is based on predetermined criteria including click-through rates, conversion rates, and overall predicted potential engagement, and it is integrated as part of the secure processing of payment (S110) and communication processes (S112) within the system. The content units, priced dynamically according to their predicted performance, are displayed via customer devices or integrated displays such as a refrigerator screen (S300), thereby providing targeted advertising that is both relevant to the user and optimized for revenue generation. The dynamic pricing mechanism operates as an additional sub-step within the method by interfacing with the overall system architecture, which includes receiving customer orders (S100), analyzing historical data (S102), and integrating further functionalities as later described.

In one embodiment, the system further comprises an augmented reality (AR) module integrated with the AI interface to enhance content unit presentation during user interactions. In this embodiment, a compatible device equipped with AR capability captures a real-time visual field, while the AR module processes sensor data from the device to accurately determine projection parameters for overlaying content units onto the live view. The system analyzes contextual information, including user location, device orientation, user preferences, and historical interaction data, to dynamically position and customize content within the AR display. The content units incorporate images, text, interactive elements, and multimedia content that are seamlessly integrated with the underlying AI-driven user interface. The AR module adjusts the presentation of content units based on real-time analytics and machine learning predictions, thereby optimizing content relevance and visibility as the viewing environment changes and as users interact with the augmented interface. Additionally, the AR system enables interactive features that allow users to engage with content content, such as initiating a web-based response, activating a call-to-action, or retrieving additional product information, all while maintaining secure and efficient operation within the broader system architecture that coordinates order placement, fulfillment, and inventory management.

In one embodiment, the method further comprises cross-platform tracking of user interactions with content units. In this embodiment, a tracking module captures data reflecting user engagements with content units across multiple platforms, including mobile devices, desktop computers, and integrated smart devices. The tracking module records various user interactions, such as clicks, hovers, time spent on contents, and other engagement metrics, and aggregates this data in a centralized manner. The aggregated interaction data is then processed by a machine learning model that correlates content engagement with user profiles and historical ordering behavior. In addition, the tracking module communicates with the secure payment and inventory modules to dynamically adjust the presentation of contents based on real-time user activity and contextual data from the ordering process. The system is configured to anonymize user data prior to aggregation to ensure compliance with data privacy regulations while still permitting effective cross-platform analysis. The resulting data is used to optimize the placement, frequency, and content of content units and to generate reports that inform advertisers of the relative success of their content campaigns across different platforms.

In additional embodiments, the method further comprises employing federated learning to improve content targeting while preserving user privacy. In these embodiments, federated learning is implemented by enabling distributed training of machine learning models on customer devices, whereby locally stored data updates the content targeting algorithm in a privacy-preserving manner without transmitting raw personal data to a central server, thereby enhancing the accuracy of content targeting while ensuring the confidentiality of user information.

The method further comprises receiving a user query through an AI interface. The user query is input by the user and includes natural language text requesting information, assistance, or content. Upon receipt, the system identifies the user by applying identification techniques such as login credentials or other authentication methods. Once the user is identified, the associated user profile is retrieved from the user profile database. The retrieved profile, which contains historical interaction information, is used to tailor subsequent processing.

Processing of the user query is accomplished using a large language model (LLM) that is configured to incorporate the user's preferences and interaction history during response generation. This incorporation enables the LLM to generate a response that is context-aware and relevant to the individual user's interests. Furthermore, the LLM maintains context across multiple interactions within a session, providing continuity and coherence in the conversation with the user.

After generating the response, the system analyzes both the generated response and the user profile to identify relevant advertising opportunities. This analysis involves determining points within the response where advertising content could be seamlessly integrated, based on factors such as subject matter relevance, user preferences, and previous engagement with similar content. The content selection process includes evaluating text-based contents with associated hyperlinks by considering the identified advertising opportunities, the user's profile data, and the current context of the query and generated response.

The method then proceeds to seamlessly integrate the selected text-based contents and associated hyperlinks within the AI-generated response. The integration is performed in such a manner that the contents appear as natural, contextually relevant parts of the response, yet they include distinguishable cues—such as visual indicators or textual framing—that differentiate the advertising content from the non-advertising portions of the response. The final composite response, which includes the embedded contents, is subsequently presented to the user through the AI interface.

Tracking user interaction with the embedded contents is a key aspect of the method. The system monitors metrics such as click-through rates on the hyperlinks, the time spent viewing the contents, and any queries or actions associated with the advertised content. This tracking data is used to update the user's profile in the database, thereby providing a more accurate and refined record of user preferences and interaction history. Additionally, machine learning algorithms are employed to continuously optimize both the content selection and integration process based on individual user interaction data, aggregated performance metrics across user segments, and changes in the advertising content and formats. This ongoing optimization enables dynamic refinement of content targeting and presentation, ensuring that the advertising content remains relevant, engaging, and contextually integrated within the AI-generated responses over time.

The disclosed methods implement specific technical solutions by: using natural language processing to extract topics and entities from the response, employing a context analyzer for real-time contextual analysis, utilizing retrieval-augmented generation to enhance the LLM's knowledge base. The method also has real-world applications by Integrating user profiles and interaction history into the response generation process, implementing an ethical scoring system for content selection, tracking and storing user interactions for continuous improvement, and demonstrating innovative data processing methods including augmenting queries with user context and external knowledge, optimizing content selection based on relevance and ethical considerations, and determining optimal content placement within the generated response.

By focusing on these aspects, the pseudo code aims to show that the invention goes beyond abstract ideas and generic computer implementation, thus addressing the concerns raised in Alice and subsequent cases regarding patent eligibility for AI and software-related inventions.

Pseudo code is as follows:

```
class AIAdvertisingSystem:
  def _{——}init_{——}(self):
    self.user_profile_db = UserProfileDatabase( )
    self.llm = LargeLanguageModel( )
    self.ad_selector = AdSelector( )
    self.interaction_tracker = InteractionTracker( )
  def process_user_query(self, user_id, query):
    # Retrieve user profile
    user_profile = self.user_profile_db.get_profile(user_id)
    # Generate response using LLM
    response = self.llm.generate_response(query, user_profile)
    # Analyze response for content opportunities
    ad_opportunities = self.analyze_response_for_ads(response, user_profile)
    # Select and embed ads
    embedded_response = self.embed_ads(response, ad_opportunities, user_profile)
    # Track interaction
    self.interaction_tracker.log_interaction(user_id, query, embedded_response)
      return embedded_response
  def analyze_response_for_ads(self, response, user_profile):
    # Implement natural language processing to identify key topics and entities
    topics = NLP.extract_topics(response)
    entities = NLP.extract_entities(response)
    # Perform real-time contextual analysis
    context = ContextAnalyzer.analyze(topics, entities, user_profile)
    return AdOpportunityFinder.find(context)
  def embed_ads(self, response, ad_opportunities, user_profile):
    selected_ads = self.ad_selector.select_ads(ad_opportunities, user_profile)
    embedded_response = ResponseEmbedder.embed_ads(response, selected_ads)
    return embedded_response
class UserProfileDatabase:
  def get_profile(self, user_id):
    # Retrieve user preferences and interaction history
    return UserProfile(user_id)
  def update_profile(self, user_id, interaction_data):
    # Update user profile based on new interactions
    profile = self.get_profile(user_id)
    profile.update(interaction_data)
    self.save_profile(profile)
class LargeLanguageModel:
  def generate_response(self, query, user_profile):
    # Incorporate user preferences and interaction history
    context = self.build_context(user_profile)
    # Use retrieval-augmented generation to supplement knowledge base
    augmented_query = self.augment_query(query, context)
    response = self.generate(augmented_query
    return response
  def build_context(self, user_profile):
    # Implement context building logic
    pass
  def augment_query(self, query, context):
    # Implement query augmentation logic
    pass
  def generate(self, augmented_query):
    # Implement response generation logic
    pass
class AdSelector:
  def select_ads(self, ad_opportunities, user_profile):
    # Implement content selection logic considering ethical guidelines
    ethical_score = self.calculate_ethical_score(ad_opportunities)
    relevant_ads = self.filter_by_relevance(ad_opportunities, user_profile)
    return self.optimize_selection(relevant_ads, ethical_score)
  def calculate_ethical_score(self, ads):
    # Implement ethical scoring system
    pass
  def filter_by_relevance(self, ads, user_profile):
    # Implement relevance filtering
    pass
  def optimize_selection(self, ads, ethical_score):
    # Implement selection optimization
    pass
class InteractionTracker:
  def log_interaction(self, user_id, query, response):
    # Track user interaction with embedded ads
    interaction_data = self.extract_interaction_data(response)
    self.store_interaction(user_id, query, interaction_data)
  def extract_interaction_data(self, response):
    # Extract relevant interaction data
    pass
  def store_interaction(self, user_id, query, interaction_data):
    # Store interaction data for future use
    pass
class ResponseEmbedder:
  @staticmethod
  def embed_ads(response, ads):
    # Implement content embedding logic
    embedded_response = response
    for content in ads:
      placement = self.determine_optimal_placement(response, ad)
      embedded_response = self.insert_ad(embedded_response, ad, placement)
    return embedded_response
    @staticmethod
  def determine_optimal_placement(response, ad):
    # Determine the best placement for the content within the response
    pass
  @staticmethod
  def insert_ad(response, ad, placement):
    # Insert the content into the response at the determined placement
    pass
# Main execution
ai_system = AIAdvertisingSystem( )
user_id = “user123”
query = “Tell me about the latest smartphones”
result = ai_system.process_user_query(user_id, query)
```

A method is provided for generating personalized video advertisements that begins with uploading a user's portrait image (S1100). In this embodiment, the user's image is received as a key input into the system, which then processes the image using artificial intelligence to convert the static portrait into a dynamic talking avatar (S1102). The system continues by precisely synchronizing the avatar's lip movements with a generated or uploaded audio script (S1104) so that the resulting animated persona speaks in a fluid and natural manner. Finally, the dynamic talking avatar is seamlessly embedded into a pre-designed video advertisement template (S1106) to generate a highly personalized advertisement.

Pseudo code for the personalized video advertisements is as follows:

```
def generate_personalized_video_ad(user_image, user_audio):
    avatar = create_talking_avatar(user_image)
    synced_avatar = sync_lip_movements(avatar, user_audio)
    return embed_in_template(synced_avatar, “ad_template.mp4”)
import cv2
import numpy as np
from moviepy.editor import VideoFileClip, AudioFileClip, CompositeVideoClip
def create_talking_avatar(user_image):
    # Load the user's image
    image = cv2.imread(user_image)
    # Detect facial landmarks
    face_cascade = cv2.CascadeClassifier(cv2.data.haarcascades +
  ‘haarcascade_frontalface_default.xml’)
    gray = cv2.cvtColor(image, cv2.COLOR_BGR2GRAY)
    faces = face_cascade.detectMultiScale(gray, 1.3, 5)
    # Assuming we found a face, let's work with the first one
    if len(faces) > 0:
      (x, y, w, h) = faces[0]
      face = image [y:y+h, x:x+w]
    else:
      raise Exception(“No face detected in the image”)
    # Create a simple animation (e.g., scaling the face)
    frames = [ ]
    for i in range(60): # 2 seconds at 30 fps
      scale = 1 + 0.1 * np.sin(i * np.pi / 30)
      scaled_face = cv2.resize(face, None, fx=scale, fy=scale)
      frames.append(scaled_face)
    return frames
def sync_lip_movements(avatar_frames, audio_file):
    # Load the audio file
    audio = AudioFileClip(audio_file)
    # Create a video clip from the avatar frames
    avatar_clip = VideoFileClip(avatar_frames)
    # Synchronize the audio with the video
    final_clip = avatar_clip.set_audio(audio)
    return final_clip
def embed_in_template(synced_avatar, template_file):
    # Load the template video
    template = VideoFileClip(template_file)
    # Resize the synced avatar to fit in the template
    resized_avatar = synced_avatar.resize(height=template.h // 3)
    # Position the avatar in the bottom right corner
    avatar_pos = (template.w − resized_avatar.w − 20, template.h − resized_avatar.h − 20)
    # Composite the avatar onto the template
    final_video = CompositeVideoClip([template, resized_avatar.set_position(avatar_pos)])
    return final_video
def generate_personalized_video_ad(user_image, user_audio):
    avatar_frames = create_talking_avatar(user_image)
    synced_avatar = sync_lip_movements(avatar_frames, user_audio)
    final_video = embed_in_template(synced_avatar, “ad_template.mp4”)
      # Write the final video to a file
    final_video.write_videofile(“personalized_ad.mp4”)
      return “personalized_ad.mp4”
# Usage
user_image_path = “user_portrait.jpg”
user_audio_path = “user_script.mp3”
personalized_ad = generate_personalized_video_ad(user_image_path, user_audio_path)
print(f“Personalized video ad created: {personalized_ad}”)
# Claim 2: Analyzing facial features for natural expressions
def analyze_facial_features(user_image):
    landmarks = detect_facial_landmarks(user_image)
    return generate_expressions(landmarks)
#: Text-to-speech for audio script generation
def generate_audio_script(text, voice_profile):
    tts_model = load_tts_model(voice_profile)
    return tts_model.generate_audio(text)
# Claim 4: Interactive voice-activated advertisements
def create_voice_activated_ad(user_voice_input):
    processed_input = process_voice_input(user_voice_input)
    ad_content = generate_ad_content(processed_input)
    return deliver_audio_ad(ad_content)
# Voice recognition for ad content tailoring
def tailor_ad_content(user_voice):
    user_id = recognize_voice(user_voice)
    user_profile = get_user_profile(user_id)
    return generate_tailored_ad(user_profile)
# Voice cloning for personalized audio ads
def clone_user_voice(voice_sample):
    voice_features = extract_voice_features(voice_sample)
    return create_voice_model(voice_features)
# Claim 7: Enhancing cloned voice naturalness
def enhance_cloned_voice(voice_model):
    speech_patterns = analyze_speech_patterns(voice_model)
    return adjust_intonation(voice_model, speech_patterns)
# Dynamic image-based ad creation
def create_dynamic_image_ad(user_photo):
    animated_image = animate_static_image(user_photo)
    return integrate_with_template(animated_image, select_ad_template( ))
Personalization engine for ad content
def personalize_ad_content(user_data, ad_template):
    user_preferences = analyze_user_preferences(user_data)
    return customize_template(ad_template, user_preferences)
# Multi-modal personalized ad generation
def generate_multimodal_ad(user_image, user_voice, user_text):
    video = create_video_from_image(user_image)
    audio = synthesize_voice(user_voice, user_text)
    return combine_video_audio(video, audio)
# Content safety measures
def implement_content_safeguards(ad_content):
    if contains_inappropriate_content(ad_content):
      return generate_safe_alternative(ad_content)
    return ad_content
# Voice-interactive podcast advertisements
def create_podcast_ad(podcast_content, user_voice):
    insertion_points = analyze_podcast_for_ad_spots(podcast_content)
    interactive_ad = generate_voice_interactive_ad(user_voice)
    return insert_ad_into_podcast(podcast_content, interactive_ad, insertion_points)
# Voice matching for podcast ads
def match_ad_voice_to_podcast(podcast_voice, ad_script):
    host_voice_profile = analyze_host_voice(podcast_voice)
    return synthesize_matching_voice(host_voice_profile, ad_script)
# Real-time personalized digital out-of-home ads
def create_realtime_dooh_ad(viewer_image):
    viewer_features = extract_viewer_features(viewer_image)
    personalized_content = generate_personalized_content(viewer_features)
    return display_ad_content(personalized_content)
# Privacy measures for viewer data
def implement_privacy_measures(viewer_data):
    anonymized_data = anonymize_viewer_data(viewer_data)
    schedule_data_deletion(anonymized_data)
    return anonymized_data
# AR advertisements with facial recognition
def create_ar_ad_with_facial_recognition(user_face):
    user_features = recognize_facial_features(user_face)
    ar_filter = generate_ar_filter(user_features)
    return apply_ar_filter_to_ad(ar_filter, “ad_template.ar”)
# Claim 17: Gesture-based AR ad interaction
def enable_gesture_interaction(ar_ad):
    gesture_recognizer = initialize_gesture_recognizer( )
    return add_gesture_controls(ar_ad, gesture_recognizer)
# Personalized in-game advertisements
def create_ingame_personalized_ad(player_avatar, game_context):
    adapted_avatar = adapt_avatar_to_game_style(player_avatar)
    return integrate_avatar_into_game_ad(adapted_avatar, game_context)
# Claim 19: In-game voice chat for audio ads
def create_ingame_voice_ad(player_voice_chat):
    player_voice_profile = analyze_player_voice(player_voice_chat)
    return generate_voice_ad(player_voice_profile, “ad_script.txt”)
# Claim 20: Adaptive social media advertisements
def create_adaptive_social_ad(user_social_data):
    content_preferences = analyze_user_content(user_social_data)
    initial_ad = generate_initial_ad(content_preferences)
  return optimize_ad_continuously(initial_ad, track_user_engagement)
```

In one design, a method for generating personalized video advertisements that includes uploading a user's portrait image; converting the static image into a dynamic talking avatar using AI technology; synchronizing the avatar's lip movements with a generated or uploaded audio script; and embedding the talking avatar into a video advertisement template. The methods can include analyzing the user's facial features to generate natural expressions and movements for the avatar. The audio script is generated using text-to-speech technology with a voice selected by the user. The inventor contemplates that the process also works with all dependencies 2-20 in the claims.

A system for creating interactive voice-activated advertisements can include a natural language processing module for understanding user voice commands; a response generation module for creating contextual ad content based on user interactions; and an audio output module for delivering personalized audio advertisements. A voice recognition module can be used for identifying individual users and tailoring ad content accordingly. The inventor contemplates that the process also works with all dependencies 2-20 in the claims.

A method for embedding user-generated content into advertisements includes capturing a user's voice sample; using AI to clone the user's voice; integrating the cloned voice into audio advertisements for personalized delivery. The method can include analyzing the user's speech patterns and intonation to enhance the naturalness of the cloned voice.

A system for creating dynamic image-based advertisements includes an image upload module for receiving user photos; an AI-powered image animation module for adding motion to static images; and an ad template library for integrating animated user images into pre-designed layouts. A personalization engine can tailor ad content based on user demographics and preferences. The inventor contemplates that the process also works with all dependencies 2-20 in the claims.

A method for generating multi-modal personalized advertisements can include combining user-provided images, voice samples, and text inputs; and using AI to create cohesive video advertisements featuring the user's likeness and voice. The method can include implementing safeguards to prevent the generation of inappropriate or sensitive content. The inventor contemplates that the process also works with all dependencies 2-20 in the claims.

A system for creating voice-interactive podcast advertisements includes a podcast content analysis module; a dynamic ad insertion module that places interactive voice ads at optimal points; and a user response tracking module for measuring engagement. A voice synthesis module optionally matches the ad's voice to the podcast host's style. The inventor contemplates that the process also works with all dependencies 2-20 in the claims.

A method for personalizing digital out-of-home advertisements includes capturing images of viewers near the display; rapidly generating custom ad content featuring viewer likenesses; and displaying the personalized ads in near real-time. Privacy measures can be added to anonymize and delete viewer data after ad display. The inventor contemplates that the process also works with all dependencies 2-20 in the claims. The inventor contemplates that the process also works with all dependencies 2-20 in the claims.

A system for creating augmented reality advertisements includes a user facial recognition module; an AR filter generation module that incorporates user features; and an ad placement module for integrating personalized AR ads into various platforms. An optional gesture recognition module allowing users to interact with the AR ad using hand movements. The inventor contemplates that the process also works with all dependencies 2-20 in the claims.

A method for generating personalized video game advertisements includes capturing player avatar data from a game; integrating the player's avatar into in-game advertising content; and dynamically updating ads based on player progress and preferences. The player's in-game voice chat samples may be used to create personalized audio ads. The inventor contemplates that the process also works with all dependencies 2-20 in the claims.

Other embodiments of one implementation relate to interactive voice-activated and image-based advertising systems. In one embodiment, a podcast content analysis module (S1200) identifies optimal moments for ad placement, and a dynamic ad insertion module (S1202) places interactive voice advertisements during these moments. A user response tracking module (S1204) then measures audience engagement, allowing for continual refinement of the displayed ads. Additional embodiments involve capturing live images of viewers near a digital display using a dedicated image capture module (S1400), rapidly generating custom advertisement content that features their likenesses (S1402), and displaying these personalized ads in near real-time (S1404) to enhance the immediacy of content relevance. The inventor contemplates that the process also works with all dependencies 2-20 in the claims.

Further embodiments integrate player-specific data within digital gaming environments. In these embodiments, player avatar data is captured (S1800) and subsequently integrated into in-game advertising content (S1802). The ads are then dynamically updated in relation to the player's progress and evolving preferences (S1804), thereby delivering a tailored advertising experience that resonates with the individual user's in-game behavior.

In one embodiment, converting the static image into a dynamic talking avatar using artificial intelligence technology, as referenced by S1102, is achieved by first analyzing the facial features of the uploaded image. Machine learning algorithms are then employed to generate realistic facial animations based on the extracted features, including nuanced lip movements and expressions. The animated output is synchronized with an audio track to produce a lifelike talking avatar that accurately mirrors the intended speech and expression.

One implementation comprises a podcast content analysis module, designated as S1200, which is designed to assess and analyze podcast content for optimal advertisement insertion. This module identifies suitable moments within the podcast where interactive voice advertisements achieve maximum impact. By scrutinizing the podcast's structure and natural breaks, S1200 enhances the ad placement strategy, ensuring that advertisements are integrated seamlessly and aligned contextually with the podcast content.

The reference label “a user response tracking module for measuring engagement S1204” refers to a component within a system designed to assess how users interact with advertisements. This module collects and analyzes data to evaluate user engagement levels, providing insights into the effectiveness of the ad placement and content. The gathered information can be used to optimize future advertisements by understanding user preferences and behaviors.

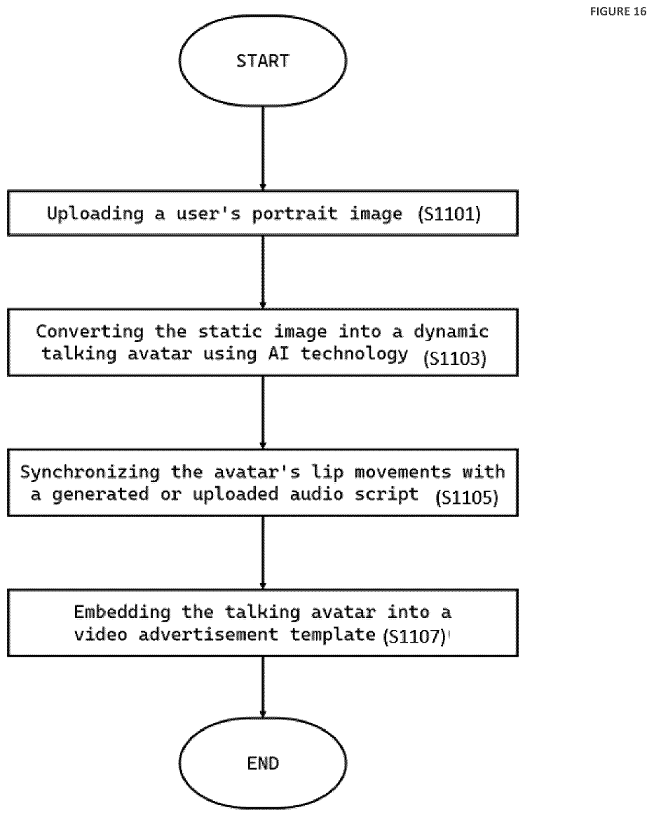

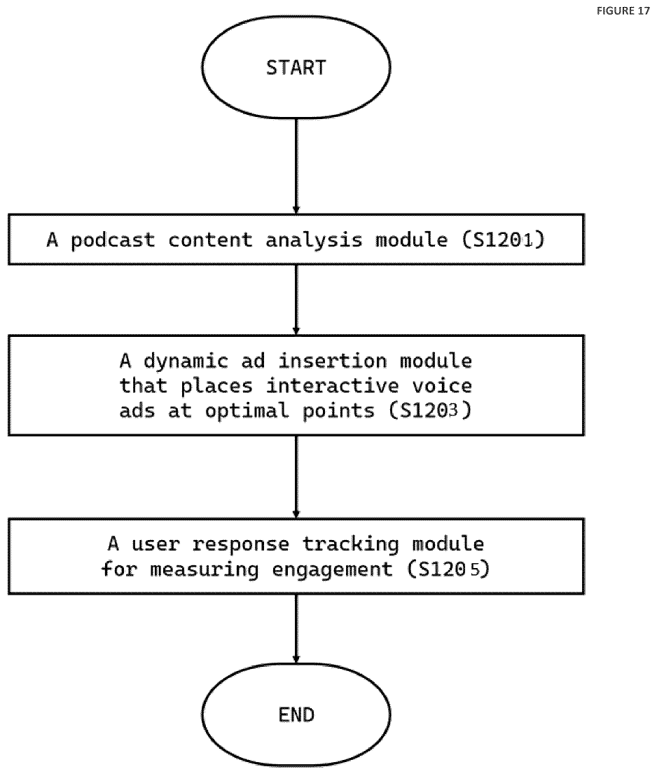

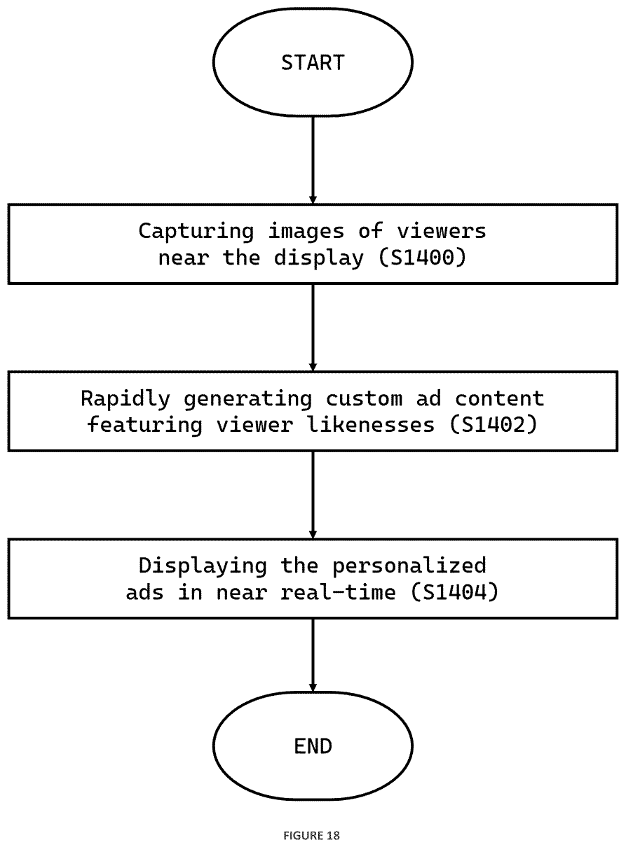

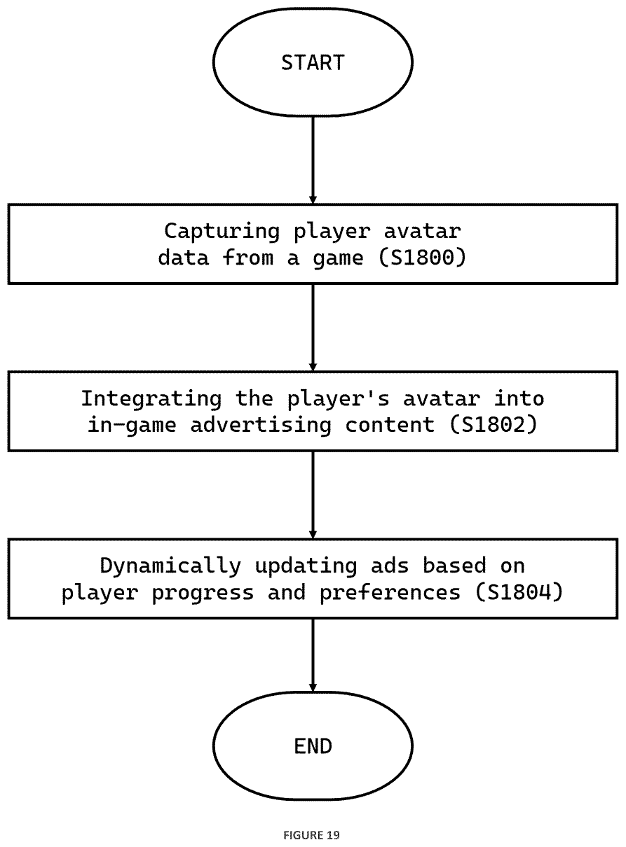

FIG. 16 illustrates the following process: capturing images of viewers near the display, rapidly generating custom ad content featuring viewer likenesses, and displaying the personalized ads in near real-time.

The reference label “capturing images of viewers near the display” (S1400) describes a process involving the use of image capture technology to obtain real-time images of individuals who are in proximity to a digital advertisement display. This step serves as the initial stage in a sequence where these captured images are subsequently used to personalize and tailor advertisement content, ensuring it is directly relevant to the viewers present.

The label “displaying the personalized ads in near real-time S1404” refers to a method step within a system. It involves the presentation of customized advertisement content on a display shortly after capturing viewer images. This rapid processing ensures that ads are tailored to individual viewers, enhancing personalization by reflecting their likenesses in the advertisements shown.

The process begins with the capture of player avatar data from a game, labeled S1800. This step involves extracting relevant details describing the player's in-game avatar, including its visual characteristics and in-game actions, to facilitate the integration of personalized advertising content.

The method involves dynamically updating in-game advertisements based on player progress and preferences, identified as S1804. This process entails analyzing the player's interactions and achievements within the game, allowing the advertising content to adapt accordingly. By aligning the ads with the player's ongoing activities and choices, a more personalized and engaging advertising experience is created, enhancing user interaction and potential conversion rates.

In one embodiment, the system further comprises a module configured to analyze the user's facial features from the uploaded portrait image to generate natural expressions and movements for the avatar. The module automatically detects and extracts key facial landmarks, such as the positions of the eyes, mouth, and eyebrows, and utilizes these parameters to derive a set of expression attributes.

These attributes are then used to produce corresponding dynamic movements and expressions for the avatar in real time, ensuring that the avatar exhibits natural and lifelike behavior. In embodiments where the avatar is animated to speak a generated or uploaded audio script, the system incorporates a text-to-speech engine configured to generate the audio script. In these embodiments, the text-to-speech engine converts input text into intelligible speech, with the voice being selected by the user from a plurality of available voice profiles. This selection enables personalization of the audio output by matching the synthesized voice characteristics to the user's preference. The generated audio script is then synchronized with the dynamically generated lip movements and expressions of the avatar, resulting in a coherent and immersive audiovisual experience.

In one embodiment, the system comprises a natural language processing module configured to receive and analyze voice commands from a user. The natural language processing module employs techniques such as acoustic signal processing, voice recognition, and semantic analysis to convert audio input into text data, thereby facilitating the interpretation of the command's intent even in the presence of background noise or varying accents. The module utilizes statistical models or machine learning algorithms to improve conversion accuracy and disambiguate similar sounding commands. The output from this module is then provided to a response generation module.

The response generation module creates contextual advertisement content by incorporating the interpreted user command along with stored advertisement data and dynamic information from external data sources. This module includes algorithms that analyze user history, contextual parameters, and current promotional targets to generate personalized advertisement content. In one embodiment, the response generation module uses natural language generation techniques to formulate responses tailored to the specific query or command provided by the user.

The system further comprises an audio output module that converts the contextual advertisement content generated by the response generation module into an audible format. The audio output module includes text-to-speech capabilities which synthesize premium quality speech, providing a personalized audio advertisement. The module also adjusts parameters such as voice pitch, speed, and intonation based on predefined user preferences or real-time analysis of user engagement metrics. These modules can be implemented as hardware components, firmware routines, computer-executable instructions stored on a non-transitory computer-readable medium, or any combination thereof, and they can be interconnected over a network or integrated within a single device.

Additional embodiments include feedback loops wherein user responses or subsequent interactions are captured and used to refine the processes of natural language understanding, response generation, and voice synthesis, thereby optimizing the overall performance of the interactive voice-activated advertisement system.

In one embodiment, the system further comprises a voice recognition module configured to identify individual users and dynamically tailor advertising content based on recognized voice input. This module operates by receiving audio data generated by a user during interactions with the system and processing the data through signal analysis algorithms to extract distinguishing voice features. The extracted features are compared against stored voice profiles to determine the identity of the user. Upon successful identification, the system is enabled to modify and deliver advertisement content that is customized to match the user's known preferences, interests, or demographic profile. The voice recognition module also integrates with other system modules, such as the dynamic ad insertion module for placing interactive voice ads at optimal points and the user response tracking module for measuring engagement, thereby enhancing the overall effectiveness of content delivery. In various embodiments, the voice recognition module is implemented in hardware, software, or a combination of both, and techniques including machine learning algorithms are utilized to continually improve identification accuracy over time. Thus, the incorporation of this module facilitates a more personalized advertising experience by leveraging biometric voice data to influence the selection and presentation of advertisement content in real time.

In one embodiment, a method for embedding user-generated content into advertisements is described. The method includes capturing a user's voice sample by employing a recording device that can be integrated into a mobile phone, computer, or dedicated audio capture system. The captured voice sample is processed to reduce background noise and normalized to ensure clarity and consistency. After capturing the voice sample, an artificial intelligence module is employed to clone the user's voice. This module utilizes deep learning techniques and voice synthesis algorithms to analyze the characteristics of the captured voice, including tone, pitch, cadence, and timbre. The AI system generates a digital clone that closely mimics the unique attributes of the user's voice. The cloned voice is then integrated into audio advertisements in a manner that enables personalized delivery. This integration step can involve synchronizing the cloned voice with preexisting audio templates or generating new advertisement content that incorporates the cloned voice, thereby customizing the audio advertisement for the specific recipient. The personalized audio advertisement is delivered through various channels, including streaming media, digital radio, or targeted online advertising, thereby enhancing user engagement and increasing advertisement relevance. The method further includes optional processes such as user confirmation steps to obtain consent for using the voice sample, ensuring compliance with data protection requirements, and additional quality control measures to verify the fidelity of the voice clone prior to advertisement deployment. Although the steps of capturing, cloning, and integrating the user's voice are described in a particular sequence, these steps can be performed in various orders or concurrently when appropriate. The method can be implemented using computer-executable instructions stored on a machine-readable medium and executed by one or more processors. Various embodiments of the method can differ in the specific techniques employed to capture the voice, clone the voice using AI, and integrate the cloned voice into audio advertisements, while still achieving the goal of providing personalized advertisement content based on user-generated voice data. The inventor contemplates that the process also works with all dependencies 2-20 in the claims.

In one embodiment, the system further comprises an analysis module operable to evaluate the user's recorded speech signals. The module captures audio input representative of the user's natural voice during the operation of generating the cloned voice. The audio signal is segmented into constituent phonetic units, and the module performs frequency analysis to extract features related to pitch, tone, and timbral characteristics. Additionally, the analysis module evaluates temporal aspects of speech, including rhythm, cadence, and pauses, to determine the overall intonation pattern of the user. Signal processing techniques, such as fast Fourier transforms and mel-frequency cepstral coefficient computation, are employed to derive quantitative measures of these vocal attributes. These measures are input into a machine learning algorithm that employs neural network architectures, calibrated to map the extracted features to parameters governing the voice synthesis process. Feedback loops iteratively compare synthesized voice outputs with the captured speech to refine the model parameters, ensuring that the resulting cloned voice retains the natural nuances of the original speech pattern. This iterative refinement process allows for dynamic adjustments to be made in the synthesis of the avatar's voice, thereby enhancing the authenticity of the output by more accurately replicating the user's natural intonation and speech dynamics. The enhanced cloned voice is then integrated into the overall system, ensuring that the avatar generates spoken content that more closely mirrors the user's unique vocal characteristics.

A system for creating dynamic image-based advertisements is provided. The system comprises an image upload module for receiving user photos, an AI-powered image animation module for adding motion to static images, and an ad template library for integrating animated user images into pre-designed layouts. In one embodiment, the image upload module accepts image data from a variety of sources, such as mobile devices and desktop computers, and performs preliminary processing including format verification and resolution adjustment. The system further performs quality assessments to ensure that the user's photo meets predetermined criteria prior to additional processing. In embodiments where the user's portrait image is uploaded, the image upload module interfaces with additional systems that verify image authenticity or perform basic editing functions.

The AI-powered image animation module processes the static image to generate subtle articulations and dynamic expressions that simulate natural movement. In particular, the animation module implements machine learning algorithms that analyze facial features and infer movements such as lip motion, eye blinks, and head tilts, thereby creating a dynamic representation of the user. The conversion process incorporates techniques including facial landmark detection, motion synthesis using trained neural networks, and temporal interpolation to produce smooth transitions between frames.

Once the animated image is generated, the ad template library integrates the animated image into one or more predetermined advertisement layouts. The ad template library contains pre-designed templates that incorporate designated placeholders for user images, text, and additional multimedia elements. These templates facilitate rapid customization by automatically inserting the animated image into a spatially and visually optimized location within the advertisement. The system ensures that the animated image is scaled, positioned, and synchronized with other advertisement components in accordance with a set of design rules, thereby producing a visually coherent and engaging advertisement. In certain embodiments, the system further refines the final output by synchronizing the animated image with optional audio elements or other dynamic content, thereby enhancing the overall impact of the advertisement.

In one embodiment, the system comprises a personalization engine configured to tailor ad content based on user demographics and preferences. The personalization engine receives input data representing various user demographic information, including age, gender, geographic location, and interests, along with preference data collected from historical interactions and behavioral patterns. It processes the received data with one or more algorithms, such as statistical analysis and machine learning techniques, to determine optimal ad content personalized for the individual user. The personalization engine receives data from modules that capture dynamic user information—for instance, modules that capture images of viewers near the display and a tracking module that measures user engagement—and is arranged to communicate with the dynamic ad insertion module to adjust the placement and timing of interactive voice ads. Furthermore, the personalization engine integrates with modules managing dynamic content, including the dynamic in-game advertising module and the module that updates advertisements based on player progress and preferences, thereby ensuring that ad content remains personalized across differing media formats. It also interacts with the module that embeds the talking avatar into a video advertisement template to adjust visual elements and to synchronize the dynamic talking avatar's expressions and lip movements with personalized audio content. By analyzing the aggregated demographic and preference data, the personalization engine generates one or more customized advertisement configurations that are transmitted to the respective output modules, ultimately resulting in ad content displayed in near real-time and optimized for the user's profile.

Following this, the AI module combines the generated dynamic avatar with the processed audio and text content by synchronizing the avatar's lip movements with the corresponding audio output. The synchronization process relies on algorithms that analyze the phonetic content of the audio sample and adjust the avatar's lip motion in real time to ensure that the visual output is consistent with the speech. With the voice, image, and text modalities effectively integrated, the method further employs an advertisement composition module that embeds the dynamic talking avatar into a video advertisement template. This template is designed to incorporate interactive graphical elements and multimedia content that enhance the overall presentation of the advertisement.

The complete process results in a cohesive video advertisement that integrates the user's likeness, voice, and preferred narrative into a personalized marketing message. The method further contemplates additional embodiments in which the personalized advertisement is tailored for various display environments and media formats, ensuring compatibility with different advertising platforms. The resulting advertisement not only reflects the unique characteristics of the user but also delivers an engaging and interactive experience, thereby enhancing user engagement and the overall impact of the advertising campaign.

The system further comprises a safeguard module configured to implement measures that prevent the generation of inappropriate or sensitive content. In one embodiment, the safeguard module is integrated into the content generation pipeline and is operable to monitor, analyze, and evaluate content produced by the system before it is output or published. The safeguard module utilizes a combination of rule-based filtering techniques and machine learning algorithms to detect and flag content that contains explicit, violent, or otherwise objectionable material. The module references a dynamically updatable lexicon of sensitive words, phrases, and contexts and employs contextual semantic analysis to assess whether content that appears objectionable is presented in an acceptable manner. If the safeguard module determines that generated content exceeds predetermined thresholds of sensitivity, the module automatically modifies the output to mitigate the identified issues, diverts the content for manual review, or prevents the content from proceeding further in the processing pipeline. The safeguards are implemented at multiple stages of content creation and deployment to ensure compliance with evolving legal and ethical standards, thereby reducing the risk of disseminating content that is deemed inappropriate or sensitive.

In one embodiment, a system for creating voice-interactive podcast advertisements is provided. The system includes a podcast content analysis module that analyzes audio files and accompanying text data from a podcast to identify content themes, natural breaks, and potential insertion points for interactive voice advertisements. In some embodiments, the podcast content analysis module evaluates linguistic and acoustic features of a podcast episode to determine optimal timing and context for placing advertisements based on listener engagement metrics and content relevance. The module further incorporates algorithms that parse the podcast script, identify patterns in speech delivery, and dynamically adjust its analysis based on real-time content variations.

Additionally, the system comprises a user response tracking module configured to measure listener engagement with the inserted voice advertisements. This module monitors auditory cues, voice command responses, and other interactive features triggered by the advertisements to assess listener reactions and quantify engagement levels. In certain embodiments, the user response tracking module employs real-time data analytics to capture metrics such as ad response time, frequency of interactivity, and sentiment analysis of voice inputs. The collected data is fed back to both the podcast content analysis module and the dynamic ad insertion module, refining future ad placements and ensuring optimal integration of advertisements within the podcast content.

In one embodiment, the system further contains a voice synthesis module configured to modify and synthesize digital audio so that the voice output of an advertisement matches the style of a podcast host. The module analyzes input audio samples representative of the podcast host's vocal characteristics—including timbre, cadence, pitch, and speech patterns—and derives corresponding voice parameters. It then uses these parameters to generate a synthesized audio stream that mirrors the host's style when delivering the advertisement content. The voice synthesis module employs machine learning algorithms, including deep neural networks or generative adversarial networks, to ensure fidelity and accurate reproduction of the host's vocal characteristics.

A method comprises capturing images of viewers near a display by utilizing an imaging subsystem configured to detect and capture live images of individuals positioned in the vicinity of a digital out-of-home display. The captured images undergo processing to extract facial features, expressions, and additional biometric data that characterize the viewer's likeness. The extracted data is provided as input to a rapid custom ad content generation engine that uses artificial intelligence algorithms to produce personalized advertisement content incorporating the viewer's likeness. This engine dynamically generates custom ad content by integrating pre-stored advertising templates with the extracted viewer features, thereby creating visually appealing and contextually relevant advertisements. The personalized advertisement is subsequently transmitted to a display control subsystem configured to render the custom ad content in near real-time on the digital out-of-home display. In one embodiment, the method further synchronizes the image capture and content generation processes with the display's refresh rate to ensure minimal latency and a seamless viewing experience. The system includes mechanisms that assess environmental factors, such as ambient lighting and viewer movement, to optimize both the capture and presentation of personalized advertisements. Optionally, the method includes additional steps for obtaining consent from the viewer and ensuring compliance with relevant privacy standards prior to capturing and processing image data. Any modifications or variations of this method that remain within the scope of the disclosed concepts are contemplated by one implementation.

A system for creating augmented reality advertisements is implemented by forming a networked architecture that includes a user facial recognition module, an AR filter generation module that incorporates user features, and an ad placement module for integrating personalized AR ads into various platforms. In one embodiment, the user facial recognition module is configured to capture and process an image of a user's face from a camera or imaging device, perform feature extraction, and verify the identity or characteristics of the user via one or more facial recognition algorithms. The module analyzes attributes such as facial shape, key landmarks, and expression details and operates in real time to provide data to subsequent processing stages.

The AR filter generation module receives the user-specific feature data from the facial recognition module and dynamically creates one or more augmented reality filters. These filters are generated by integrating the extracted facial features with graphical overlays, animations, and other visual elements that tailor the display to the user's unique appearance. The module uses stored templates, incorporates predefined effects, or dynamically generates custom filter content based on the user's characteristics, environmental parameters, or contextual data. The process of filter generation includes steps such as image segmentation, scaling, alignment of graphical elements with facial landmarks, and real-time rendering of animated overlays.

The ad placement module is coupled to the AR filter generation module and is responsible for embedding the personalized AR advertisements into various media platforms. This module selects appropriate target platforms such as mobile devices, web-based applications, in-store digital displays, or other interactive environments, and orchestrates the timing and method of advertisement insertion. The selection process is driven by factors such as user engagement data, location information, platform capabilities, or advertiser-defined criteria. In certain embodiments, the ad placement module is further adapted to update the displayed advertisement content dynamically in response to user interactions, changes in contextual data, or progression in user behavior metrics.

In one exemplary embodiment, the system further comprises a gesture recognition module allowing users to interact with the AR ad using hand movements. The gesture recognition module is configured to detect and interpret a range of hand gestures performed by the user, thereby enabling interactive control of the AR advertisement. In certain embodiments, the module includes one or more sensors that capture hand motion and position data in real time, and a processing unit that analyzes the captured data to distinguish between different gestures. The recognition module maps the detected gestures to corresponding actions within the advertisement, such as scrolling through content, selecting interactive elements, or triggering additional multimedia features. By integrating the gesture recognition module with the AR advertisement system, the apparatus provides an intuitive, touch-free means for users to control and interact with displayed content, thereby enhancing user engagement and the overall interactivity of the advertisement.

In certain embodiments, the system further comprises a module configured to utilize the player's in-game voice chat samples to create personalized audio ads. In these embodiments, the player's voice chat samples are captured during gameplay, and the captured audio is processed by a voice analysis module to extract distinctive vocal characteristics such as tone, pitch, and cadence. The extracted vocal characteristics are then used by an audio synthesis module to generate personalized audio content that is tailored to match the player's unique voice profile. In this manner, the personalized audio ads incorporate elements of the player's vocal identity, resulting in dynamic audio advertisements that engage the user.

1. A method for delivering targeted content in one or more artificial intelligence (AI) generated responses to a user or a software of a client processor, comprising:
receiving by a client processor a user input comprising one or more user or software queries;
transmitting by the client device the user input to an AI processor;
processing the one or more user or software queries using a large language model (LLM) by the AI processor to generate a response;
analyzing by the AI processor the generated response to identify one or more content placement opportunities;
selecting by the AI processor one or more hyperlinked content units based on the identified one or more content placement opportunities;
transmitting the generated response and the selected one or more hyperlinked content units to the client processor;
embedding the selected one or more hyperlinked content units within the generated response by the client processor;
presenting the response with the embedded one or more hyperlinked content units to the user or the software;
tracking the user or the software interaction with the embedded one or more hyperlinked content units.

2. The method of claim 1, wherein the query comprises a conversational AI assistant or an AI-powered search engine, and wherein the response comprises a multi-modal response with text, audio, or audiovisual content.

3. The method of claim 1, wherein the LLM is trained on domain-specific data to enhance response relevance.

4. The method of claim 1, wherein selecting the hyperlinked content units is based on user profile data and wherein selecting the hyperlinked content units is based on real-time contextual analysis of the user query and the generated response.

5. The method of claim 1, wherein the hyperlinked content units are dynamically generated using AI-powered content creation tools.

6. The method of claim 1, wherein embedding the hyperlinked content units includes determining optimal placement or optimizing content unit selection and placement based on historical performance data to maximize visibility and relevance.

7. The method of claim 1, further comprising personalizing the hyperlinked content units based on user preferences and behavior.

8. The method of claim 1, wherein the hyperlinked content units are designed to visually integrate with the AI-generated response.

9. The method of claim 1, wherein the hyperlinked content units include multimedia content including sounds, images or videos.

10. The method of claim 1, wherein the one or more user or software queries includes voice and image-based inputs.

11. The method of claim 1, comprising cross-platform tracking of the interactions with the one or more hyperlinked content units.

12. The method of claim 1, further comprising using federated learning.

13. The method of claim 1, further comprising receiving one or more biddings from one or more advertisers.

14. The method of claim 1, wherein the hyperlinked content units are designed to be interactive within the AI interface.

15. The method of claim 1, wherein the selecting further comprises using sentiment analysis.

16. The method of claim 1, wherein the processing the one or more user or software queries comprises adapting the query to different languages or cultural contexts for global advertising campaigns.

17. The method of claim 1, wherein the tracking further comprises using a blockchain to ensure transparency and security in one or more hyperlinked content units.

18. The method of claim 1, wherein the presenting of the response comprises using augmented reality (AR) to enhance the one or more hyperlinked content units.

19. The method of claim 1, wherein the hyperlinked content units can trigger AI-powered chatbots for further product information.

20. The method of claim 1, further comprising embedding the selected hyperlinked content units within the generated response by:
analyzing the semantic structure of the response to identify one or more breakpoints for, content placement; and
providing a disclosure to the user that the embedded content is sponsored or advertising material.

21. A method for delivering personalized, context-aware advertising content in artificial intelligence (AI) generated responses to a user query, comprising:
establishing a user profile database to store individual user preferences and interaction history;
identifying a user and retrieving data from the user profile database;
processing the user query using a large language model (LLM) to generate a response, wherein the LLM incorporates the user's preferences and interaction history in the response generation process and maintains context awareness across multiple interactions within a session;
analyzing the generated response and user profile to identify one or more advertising opportunities;
selecting one or more text-based contents with one or more hyperlinks based on the identified advertising opportunities;
integrating the selected contents and the one or more hyperlinks within the generated response, where the contents appear as in one or more relevant parts of the response and distinguishable from the AI-generated content;
presenting the response to the user;
tracking user interaction with the embedded contents, including click-through rates on the one or more hyperlinks and time spent viewing or interacting with the advertised content, queries or actions related to the advertised content;
updating the user's profile in the database based on their interactions with the contents and the response;
using machine learning to optimize the content selection based on individual user interaction data, aggregated performance metrics across user segments, and advertising content and formats.
analyze a single generated response to identify a relevant content placement opportunity within said generated response, and selecting the hyperlinked content based on the identified relevant content placement opportunity
